(19) United States
(12) Patent Application Publication
(10) Pub. No.: US 2010/0026932 A1
(43) Pub. Date: Feb. 4, 2010

(54) LIQUID CRYSTAL DISPLAY DEVICE

(76) Inventors: Ryo SATAKE, Minami-Ashigara-shi (JP); Yoshiaki Hisakado, Minami-Ashigara-shi (JP); Jun Watanabe, Minami-Ashigara-shi (JP)

Correspondence Address: BIRCH STEWART KOLASCH & BIRCH, PO BOX 747, FALLS CHURCH, VA, 22040-0747, US

(21) Appl. No.: 12/533,682

(22) Filed: Jul. 31, 2009

(30) Foreign Application Priority Data
Aug. 1, 2008 (JP) P2008-200265

(51) Int. Cl. G02F 1/13357

(52) U.S. Cl. 349/64

(57) ABSTRACT

A liquid crystal display device including: a light source; a polarizing film of light source side; a liquid crystal cell; and a polarizing film of display side is provided, the liquid crystal display device further comprising: an optical compensatory sheet disposed between the liquid crystal cell and the polarizing film of the light source side or between the liquid crystal cell and the polarizing film of the display side; and a light-scattering sheet disposed at an outermost surface of the polarizing film of display side, wherein luminance in a normal direction with respect to the liquid crystal display device in a black display state without the light-scattering sheet is 0.3 cd/m² or less, maximum value of black luminance in a polar angle range within 600 with respect to the normal direction is 2.0 cd/m² or less, and total haze of the light-scattering sheet is from 30 to 90%.

### BACKGROUND OF THE INVENTION

1. Field of the Invention

The present invention relates to a liquid crystal display device which corrects viewing angle dependence of tint of display in the white display state and in the black display state and which suppresses reduction of contrast.

2. Description of the Related Art

### (Display Device)

Image display devices represented by liquid crystal display (LCD), plasma display panel (PDP), CRT, and EL are being used in various fields including televisions and computers, and have made remarkable development. In particular, LCD is remarkably spread as a thin and light-weight display having rich general-purpose properties for various devices such as thin-model flat panel televisions, mobile phones, personal computers, digital cameras, and PDAs.

With these display devices, there are many chances of viewing not only letter information but an image having many intermediate gradations such as a human face image or a landscape image from various directions. Therefore, it has been desired that the impression of an image does not change when viewed from any direction.

As a display mode of LCD, there have been developed TN-mode, VA-mode, IPS-mode, OCB-mode, etc. The liquid crystal display devices of these display modes are different from each other in the alignment pattern of liquid crystal, and have different image display characteristics. In particular, problems of deteriorating image quality which are peculiar to the liquid crystal alignment pattern, such as gradation-reversing characteristics with TN-mode upon viewing from downward and whiteout characteristics with VA-mode, arise, and hence viewing angle performance must properly be corrected.

### (Optical Compensatory Sheet)

As a technique for improving viewing angle performance of a display, there are optical functional sheets to be used for a display member such as LCD or PDP. The optical functional sheets have a support such as triacetyl cellulose (TAC) or polyethylene terephthalate (PET) which also functions as a protective film, and have functions according to various uses. Among them, an optical compensatory sheet is used in various liquid crystal display devices for removing coloration of image or for enlarging the viewing angle. As the optical compensatory sheet, stretched birefringence polymer films have conventionally been used and, other than the stretched birefringence films, there has been proposed an optical compensatory film having on a transparent support an optically anisotropic layer formed from a low-molecular or high-molecular liquid crystalline compound. Since liquid crystalline compounds have various alignment patterns, it becomes possible to realize optical properties that cannot be obtained with the conventional stretched birefringence polymer films, by using the liquid crystalline compounds.

For example, JP-A-8-50206 proposes an optical compensatory sheet comprising a transparent support and an optically anisotropic layer provided thereon, wherein the optically anisotropic layer is a layer with a negative birefringence composed of a compound having discotic structural units, with the angle between the disc plane of the discotic structural unit and the transparent support changing in the depth direction of the optically anisotropic layer.

Also, JP-A-2002-196146 proposes an optical compensatory sheet having the above-mentioned optically anisotropic layer on a transparent support whose in-plane retardation (Re) and thickness direction retardation (Rth) are within a given range.

Further, JP-A-2001-100031 proposes an optical compensatory sheet having the above-mentioned optically anisotropic layer on a polymer film which has optically positive mono-axial or optically bi-axial properties and wherein the direction of the maximum refractive index is substantially parallel to the polymer plane, with the direction of the maximum refractive index of the polymer film being substantially parallel to, or perpendicular to, the average direction of lines obtained by projecting the normal lines of the disc planes of individual discotic liquid crystalline molecules in the optically anisotropic layer onto the plane of the polymer film.

### (Light-Scattering Sheet)

Also, a light-scattering sheet is used for the purpose of scattering the transmitted light of a display to thereby improve viewing angle characteristics intrinsic to the display. The light-scattering sheet is constituted by a binder for forming the sheet and light-scattering particles for scattering the transmitted light based on difference in refractive index between the binder and the particles (JP-A-2006-259003).

However, conventional light-scattering sheets have failed to sufficiently suppress change in color tint, though they have the effect of enlarging the viewing angle or of preventing reversal.

In recent years, it has been attempted to suppress change in color lint and change in gamma with respect to VA-mode liquid crystal display devices by mounting a light-scattering sheet capable of strongly scattering light of short wavelength using particularly small particles with a particle size of sub-micron order (JP-A-2007-248803, JP-A-2007-249038, JP-A-2008-58386 and JP-A-2008-64835). However, the above-mentioned display devices have the problems that, since the scattered light caused by the light-scattering sheet diffuses widely, front contrast is decreased and that, since it is applicable only to VA-mode liquid crystal display devices among liquid crystal display devices of various modes, it has poor general-purpose properties.

### SUMMARY OF THE INVENTION

In consideration of the above-mentioned problems, an object of the invention is to provide a liquid crystal display device, particularly a transmission type liquid crystal display device, which corrects viewing angle dependence of color tint of display in the white display state and in the black display state and which suppresses reduction of contrast.

As a result of intensive investigations, the inventors have found that the above-mentioned problems can be solved by the liquid crystal display device of the following constitution.

(1) A liquid crystal display device, including: a light source; a polarizing film of light source side; a liquid crystal cell; and a polarizing film of display side, in this order,

the liquid crystal display device further comprising:

an optical compensatory sheet disposed between the liquid crystal cell and the polarizing film of the light source side or between the liquid crystal cell and the polarizing film of the display side; and

a light-scattering sheet disposed at an outermost surface of the polarizing film of display side,

wherein luminance in a normal direction with respect to the liquid crystal display device in a black display state without the light-scattering sheet is 0.3 cd/m² or less, maximum value of black luminance in a polar angle range within 60° with respect to the normal direction is 2.0 cd/m² or less, and total haze of the light-scattering sheet is from 30 to 90%.

(2) The liquid crystal display device as described in item (1) above,

wherein the light-scattering sheet includes:

a transparent support; and

a light-scattering layer,

with the light-scattering layer being constituted by a light-transmitting resin and a light-scattering body,

wherein the light-transmitting resin is cured by at least one of heat and ionizing radiation, and the light-scattering body is different from the light-transmitting resin in refractive index.

(3) The liquid crystal display device as described in item (2) above,

wherein the light-scattering body in the light-scattering sheet is light-transmitting particles.

(4) The liquid crystal display device as described in item (3) above,

wherein a difference between a refractive index (nB) and a refractive index (nP) is from 0.03 to 0.2, the refractive index (nB) representing a refractive index of the light-transmitting resin and the refractive index (nP) representing a refractive index of the light-transmitting particles in the light-scattering sheet.

(5) The liquid crystal display device as described in item (4) above,

wherein the refractive index (nB) is lower than the refractive index (nP).

(6) The liquid crystal display device as described in any of items (2) to (5) above,

wherein the light-scattering body contained in the light-scattering sheet is particles having a particle size of from 0.5 to 6 μm.

(7) The liquid crystal display device as described in any of items (1) to (6) above, the liquid crystal display device further including:

a low refractive index layer having a refractive index of from 1.20 to 1.46, the low refractive index layer being provided over the light-scattering sheet as an antireflection layer.

(8) The liquid crystal display device as described in any of items (1) to (7) above,

wherein the optical compensatory sheet has at least one of optically anisotropic layers including a first optically anisotropic layer and a second optically anisotropic layer,

the first optically anisotropic layer including at least one sheet of polymer film, and the second optically anisotropic layer being formed from a transparent support and a low-molecular or high-molecular liquid crystalline compound.

(9) The liquid crystal display device as described in item (8) above,

wherein the first optically anisotropic layer of the optical compensatory sheet has an optically positive mono-axial or bi-axial properties, and

the first optically anisotropic layer has a value of Re(630) which is larger than a value of Re(450), the value of Re(630) representing an in-plane retardation at a wavelength of 630 nm and the value of Re(450) representing an in-plane retardation at a wavelength of 450 nm.

(10) The liquid crystal display device as described in item (8) or (9) above,

wherein the first optically anisotropic layer of the optical compensatory sheet satisfies following formula (A):

5 nm≦ΔRe(630−450)≦45 nm (A)

wherein ΔRe(630−450) represents a difference between Re(630) and Re(450), where Re(630) represents an in-plane retardation at wavelength of 630 nm; and Re(450) represents an in-plane retardation at wavelength of 450 nm.

(11) The liquid crystal display device as described in any of items (8) to (10) above,

wherein the first optically anisotropic layer of the optical compensatory sheet satisfies following formulae (B) and (C):

50 nm≦Rth(550)≦140 nm (B)

0.5≦Rth(550)/Re(550)≦6.0 (C)

wherein Re(550) represents an in-plane retardation value to light having a wavelength of 550 nm; and Rth(550) represents a retardation value in a thickness direction to light having a wavelength of 550 nm.

(12) The liquid crystal display device as described in any of items (8) to (11) above,

wherein the first optically anisotropic layer of the optical compensatory sheet satisfies following formula (D):

ΔRth(630−450)≦30 nm (D)

wherein ΔRth(630−450) represents a difference between Rth(630) and Rth(450), where Rth (630) represents a retardation value in a thickness direction to light having wavelength of 630 nm; and Rth (450) represents a retardation value in a thickness direction to light having wavelength of 450 nm.

(13) The liquid crystal display device as described in any of items (1) to (12) above, wherein the liquid crystal cell is of TN-mode.

### BRIEF DESCRIPTION OF THE DRAWINGS

FIG. 1 shows a view showing a preferred scattering profile of the light-scattering sheet in the present invention.

### DETAILED DESCRIPTION OF THE INVENTION

The present invention is described in more detail below.

Additionally, in this specification, the numerical range represented by “from ** to **” means the range including the numerical values set forth before and after “to” as lower and upper limits, respectively.

In this specification, Re(λ) and Rth(λ) indicate the in-plane retardation (nm) and the thickness direction retardation (nm) of a film at a wavelength of λ, respectively. Re(λ) is determined, using KOBRA 21ADH or WR (manufactured by Oji Scientific Instruments), with light having a wavelength of λnm given to a film in the normal direction thereof.

In the case where the film to be analyzed is a mono-axial or bi-axial refractive index ellipsoid, its Rth(λ) is calculated as follows:

Rth(λ) is calculated with KOBRA 21ADH or WR based on the retardation value that is obtained by measuring the Re(λ) at a total of 6 points in directions inclined every 10° from the normal direction thereof to +50° from the normal line relative to the film surface around an in-plane slow axis (determined by KOBURA 21ADH or WR) as an inclination axis (rotation axis) (in the case where the film does not have a slow axis, any desired in-plane direction of the film may be taken as the rotation axis) for an incident light of a wavelength of λnm entering from each of the directions of inclination, an assumed average refraction index, and inputted film thickness.

In the above description, for the film having a tilt angle at which the retardation thereof is zero with the in-plane slow axis from the normal direction taken as the rotation axis, its retardation at a tilt angle larger than that tilt angle is converted into the corresponding negative value and then calculated by KOBRA 21ADH or WR.

Additionally, with the slow axis taken as the tilt axis (rotation axis) (in the case where the film does not have a slow axis, any desired in-plane direction of the film may be taken as the rotation axis), a retardation is determined in any desired two tilt directions and, based on the found data and the assumed average refractive index and the inputted film thickness, Rth of the film may also be calculated according to the following formulae (1) and (2):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & formula ( 1 ) \\ Rth = ( \frac{nx + ny}{2} - nz ) \times d & formula ( 2 )\end{matrix}$$

In the above formula, Re(θ) represents a retardation in the direction tilted by an angle θ from the normal direction; nx represents the refractive index in the in-plane slow axis direction; ny represents the refractive index in the direction perpendicular to the in-plane nx; nz represents the refractive index in the direction perpendicular to nx and ny; and d represents the thickness of the film.

In the case where the film to be analyzed cannot be expressed as a mono-axial or bi-axial refractive index ellipsoid, or in the case where the film to be analyzed has no so-called “optical axis”, then its Rth(λ) may be calculated as follows.

Rth(λ) is calculated with KOBRA 21ADH or WR based on the retardation value that is obtained by measuring the Re (λ) at a total of eleven points in directions inclined every 10° from −50° up to +50° from the normal line relative to the film surface around an in-plane slow axis (determined by KOBURA 21ADH or WR) as an inclination axis (rotation axis) for an incident light of a wavelength of λnm entering from each of the directions of inclination, an assumed average refraction index and inputted film thickness.

In the above measurement, as the assumed average refractive index, catalogue values with various optical films described in Polymer Hand-book (JOHN WILEY & SONS, INC.) may be employed. With polymers having unknown average refractive index, the value may be obtained by measuring using an Abbe's refractometer. Average refractive indices of major optical films are illustrated below: cellulose acylate (1.48); cycloolefin polymer (1.52); polycarbonate (1.59); polymethyl methacrylate (1.49); and polystyrene (1.59).

By inputting the value of these assumed average refraction indices and film thickness, KOBRA 21ADH or WR calculates nx, ny, and nz. Further, Nz=(nx−nz)/(nx−ny) is calculated from the calculated nx, ny, and nz.

Also, in this specification, when no specific description is given to wavelength, Re and Rth are for the light having a wavelength of 550 nm.

### <Liquid Crystal Display Device>

### [Constitution of Liquid Crystal Display Device]

An embodiment of the present invention is described below.

The liquid crystal display device of the invention is a liquid crystal display device having disposed therein a light source, a polarizing film of the light source side, a liquid crystal cell, and a polarizing film of the display side in this order, wherein an optical compensatory sheet is disposed between the liquid crystal cell and the polarizing film of the light source side or between the liquid crystal cell and the polarizing film of the display side and a light-scattering sheet is disposed at the outermost surface of the polarizing film of the display side, with the luminance in the normal direction with respect to the liquid crystal display device in the black display state without the light-scattering sheet being 0.3 cd/m² or less, the maximum value of black luminance in the polar angle range within 60° with respect to the normal direction being 2.0 cd/m² or less, and the total haze of the light-scattering sheet being from 30 to 90%.

The optical compensatory sheet to be used in the invention has an optically anisotropic layer, and it is preferred to dispose one optical compensatory sheet between the liquid crystal cell and one of the polarizing films or to dispose two optical compensatory sheets between the liquid crystal cell and each of the polarizing films. Also, the light-scattering sheet is particularly advantageously used for improving color tint of the liquid crystal display device, and is preferably used as the outermost layer. Additionally, in the following description, the polarizing film may in some cases be referred to as “polarizing plate”.

The liquid crystal display device of the invention is not particularly limited to that which has the above-mentioned constitution, and may have other members. For example, a color filter may be disposed between the liquid crystal cell and the polarizing film. Also, in the case of using as a transmission type display device, a cold or hot cathode fluorescent tube or a backlight using a light-emitting diode, a field emission element or an electroluminescent element as a light source may be disposed on the back side. Also, the liquid crystal display device may be of a reflection type. In such case, it suffices to dispose one polarizing plate on the viewing side, with a reflecting film being provided on the back side of the liquid crystal cell or inside of the lower substrate of the liquid crystal cell. It is of course possible to provide a front light using the light source on the viewing side of the liquid crystal cell. Further, the liquid crystal display device of the invention may be of a semi-transmission type wherein a reflective domain and a transmissive domain are provided in one pixel of the display device in order to attain both the transmission mode and the reflection mode.

The liquid crystal display device of the invention includes devices of an image direct view type, image projection type and light modulation type. In particular, the invention exerts effectiveness when it is applied to an embodiment of an active matrix liquid crystal display device using a three-terminal or two-terminal semiconductor element such as TFT or MIM. Of course, an embodiment in which the invention is applied to a passive matrix liquid crystal display device referred to as time division driving is also effective.

### <Liquid Crystal Mode>

As the liquid crystal display device of the invention, there are such types as a VA-type liquid crystal display device, a TN-type liquid crystal display device, an OCB-type liquid crystal display device, an ECB-type liquid crystal display device, and an IPS-type liquid crystal display device according to the alignment mode of the liquid crystal cell as described hereinbefore. Of these, TN-mode devices exert the most effect in the embodiment of the invention. In the TN-mode liquid crystal cell, rod-shaped liquid crystalline molecules are substantially horizontally aligned and further twist-aligned to from 60 to 120° upon not applying voltage. The TN-mode liquid crystal cell is most popularly utilized as a color TFT liquid crystal display device and is described in many literatures. Since viewing angle dependence of change in color tint accompanying alignment of a liquid crystal cell also arises with liquid crystal display devices of any mode other than the TN-mode device, the effects of the invention are obtained with those devices. Thus, the embodiments of the invention are not limited only to the TN-mode.

### (First Optically Anisotropic Layer)

The first optically anisotropic layer of the optical compensatory sheet preferably comprises at least one polymer film sheet. The first optically anisotropic layer preferably functions also as a transparent support of the optical anisotropic layer. It is also possible to constitute the transparent support with a plurality of polymer films to attain the optically anisotropic properties defined by the invention. However, it is possible to realize the optically anisotropic properties defined by the invention by using one polymer film sheet. Thus, the first optically anisotropic layer is particularly preferably composed of one polymer film sheet.

The average value of the slow axis angle of the polymer film is preferably 3° or less, more preferably 2° or less, most preferably 1° or less. A direction of the average value of the slow axis angle is defined as an average direction of the slow axis. Also, a standard deviation of the slow axis angle is preferably 1.5° or less, more preferably 0.8° or less, most preferably 0.4° or less. The angle of the slow axis in the polymer film plane is defined by an angle formed by the slow axis and a standard line (0°) which is a stretching direction of the polymer film. When the roll-shaped film is stretched in a width direction, the width direction is defined as the standard line; and when it is stretched in a longitudinal direction, the longitudinal direction is defined as the standard line. The polymer film preferably has a light transmittance of 80% or more. The polymer film preferably has a photoelastic constant of not more than 60×10⁻¹² m²/N.

In the transmission type liquid crystal display device using the optical compensatory sheet, there may be the case where, after a lapse of time after turning on electricity, “picture frame-like display unevenness” is generated in the surroundings of a screen. This unevenness is caused due to an increase of the transmittance in the surroundings of a screen and, in particular, becomes serious at the time of black display. In the transmission type liquid crystal display device, heat generation from a backlight occurs, and temperature distribution is generated in the liquid crystal cell plane. That the optical characteristics (for example, a retardation value and a slow axis angle) of the optical compensatory sheet are changed by this temperature distribution is a cause of the generation of “picture frame-like display unevenness”. The change of the optical characteristics of the optical compensatory sheet is caused due to the generation of elastic deformation in the optical compensatory sheet because expansion or shrinkage of the optical compensatory sheet due to the temperature increase is suppressed by the adhesion to the liquid crystal cell or polarizing plate.

In order to suppress the “display unevenness” generated in the transmission type liquid crystal display device, it is preferred to use a polymer film with high heat conductivity for the transparent support of the optical compensatory sheet. Examples of the polymer with high heat conductivity include cellulose based polymers such as cellulose acetate (heat conductivity (hereinafter the same): 0.22 W/(m·K)); polyester based polymers such as polycarbonate (0.19 W/(m·K)); and cyclic polyolefin polymers such as norbornene based polymers (0.20 W/(m·K)).

Commercially available polymers, for example, commercially available norbornene based polymers (ARTON, manufactured by JSR Corporation; ZEONOR, manufactured by Zeon Corporation; and NEONEX, manufactured by Zeon Corporation) may be used. Polycarbonate based copolymers are described in JP-A-10-176046 and JP-A-2001-253960.

An aromatic compound having at least two aromatic rings can be used as a retardation increasing agent in order to adjust the retardation of the polymer film.

In the case where a cellulose acetate film is used as the polymer film, the aromatic compound is used in an amount ranging from 0.01 to 20 parts by weight per 100 parts by weight of the cellulose acetate. The aromatic compound is preferably used in an amount ranging from 0.05 to 15 parts by weight, more preferably ranging from 0.1 to 10 parts by weight, per 100 parts by weight of the cellulose acetate. Two or more of the aromatic compounds may be used in combination thereof.

The aromatic ring of the aromatic compound includes, in addition to an aromatic hydrocarbon ring, an aromatic heterocyclic ring.

The retardation increasing agent preferably has a molecular weight of from 300 to 800. The retardation increasing agent is described in JP-A-2000-111914, JP-A-2000-275434, JP-A-2001-166144 and WO 00/02619.

### (Manufacturing of Polymer Film)

It is preferred that the polymer film is produced by a solvent casting method. In the solvent casting method, the film is produced using a solution (dope) having a polymer dissolved in an organic solvent. It is preferred that the organic solvent includes a solvent selected among an ether having from 2 to 12 carbon atoms, a ketone having from 3 to 12 carbon atoms, an ester having from 2 to 12 carbon atoms, and a halogenated hydrocarbon having from 1 to 6 carbon atoms.

Each of the ether, ketone, and ester may have a cyclic structure. A compound having any two or more of functional groups of an ether, a ketone, and an ester (that is, —O—, —CO—, and —COO—) can also be used as the organic solvent. The organic solvent may have other functional group such as an alcoholic hydroxyl group.

Examples of the ether include diisopropyl ether, dimethoxymethane, dimethoxyethane, 1,4-dioxane, 1,3-dioxolane, tetrahydrofuran, anisole, and phenetole. Examples of the ketone include acetone, methyl ethyl ketone, diethyl ketone, diisobutyl ketone, cyclohexanone, and methylcyclohexanone. Examples of the ester include ethyl formate, propyl formate, pentyl formate, methyl acetate, ethyl acetate, and pentyl acetate. Examples of the organic solvent having two or more kinds of functional groups include 2-ethoxyethyl acetate, 2-methoxyethanol, and 2-butoxyethanol. The carbon atom number of the halogenated hydrocarbon is preferably 1 or 2, most preferably 1. The halogen of the halogenated hydrocarbon is preferably chlorine. The proportion at which the hydrogen atom of the halogenated hydrocarbon is substituted with a halogen is preferably from 25 to 75 mol %, more preferably from 30 to 70 mol %, still more preferably from 35 to 65 mol %, most preferably from 40 to 60 mol %. Methylene chloride is a representative halogenated hydrocarbon. Two or more kinds of the organic solvents may also be used in combination thereof.

The polymer solution can be prepared by a general method. The “general method” as referred to herein means a treatment at a temperature of 0° C. or higher (ordinary temperature or high temperatures). The preparation of the solution can be carried out by using a dope-preparing method and a dope-preparing apparatus employed in a usual solvent casting method. Additionally, in the case of the general method, it is preferred to use a halogenated hydrocarbon (in particular, methylene chloride) as the organic solvent. The polymer solution is prepared in such a manner that the polymer is contained in the solution in an amount of from 10 to 40% by weight. The amount of the polymer is more preferably from 10 to 30% by weight. An arbitrary additive to be described later may be added in the organic solvent (major solvent). The solution can be prepared by stirring a polymer and an organic solvent at ordinary temperature (from 0 to 40° C.). The solution with high concentration may be stirred under a pressure and heating condition. Specifically, a polymer and an organic solvent are charged in a pressure vessel and sealed, and the mixture is stirred while heating at a temperature in the range of a boiling point of the solvent at ordinary temperature or higher under pressure and not higher than a temperature at which the solvent boils. The heating temperature is usually 40° C. or higher, preferably from 60 to 200° C., more preferably from 80 to 110° C.

The respective components may be roughly mixed in advance and then charged in a vessel. Also, the components may be thrown into the vessel successively. The vessel is required to be constituted such that stirring can be performed. The vessel can be pressurized by injecting an inert gas such as a nitrogen gas thereinto. Also, an increase of a vapor pressure of the solvent due to heating may be utilized. Alternatively, after sealing the vessel, the respective components may be added under pressure.

In the case of heating, it is preferred that the heating is carried out from the outside of the vessel. For example, a jacket type heating device can be used. Also, the whole of the vessel can be heated by providing a plate heater outside the vessel, piping and circulating a liquid.

It is preferred to provide a stirring blade in the inside of the vessel and perform stirring by using this. The stirring blade is preferably one having a length such that it reaches in the vicinity of a wall of the vessel. It is preferred that a scraping blade is provided at the terminal end of the stirring blade for the purpose of renewing a liquid film of the wall of the vessel.

Measuring instruments such as a pressure gauge and a thermometer may be provided in the vessel. In the vessel, the respective components are dissolved in a solvent. The prepared dope is cooled and then taken out from the vessel, or taken out from the vessel and then cooled by using a heat exchanger or the like.

The polymer solution (dope) can also be prepared by a cooling dissolution method. First of all, a polymer is gradually added in an organic solvent at a temperature around room temperature (from −10 to 40° C.) while stirring. In the case of using plural solvents, the addition order thereof is not limited. For example, after adding a polymer in a major solvent, other solvent (for example, a gelling solvent such as an alcohol) may be added. Conversely, a major solvent may be added after previously wetting a polymer with a gelling solvent, and such is effective for preventing heterogeneous dissolution from occurring. It is preferred that the amount of the polymer is adjusted such that from 10 to 40% by weight of the polymer is contained in this mixture.

The amount of the polymer is more preferably from 10 to 30% by weight. Furthermore, an arbitrary additive to be described later may be added to the mixture.

Next, the mixture is cooled to a temperature of from −100 to −10° C. (preferably from −80 to −10° C., more preferably from −50 to −20° C., most preferably from −50 to −30° C.). The cooling can be carried out in, for example, a dry ice/methanol bath (−75° C.) or a cooled diethylene glycol solution (from −30 to −20° C.). By performing cooling in such a manner, the mixture of a polymer and an organic solvent is solidified. The cooling rate is not particularly limited but, in the case of batchwise cooling, the viscosity of the polymer solution increases accompanying cooling, leading to deterioration of the cooling efficiency. Therefore, it is necessary to use a still with good efficiency for the purpose of reaching a predetermined cooling temperature.

In the cooling dissolution method, the polymer solution may be transferred, after swelling, through a cooling unit set up at a predetermined cooling temperature in a short period of time. It is preferred that the cooling rate is as fast as possible. However, 10,000° C./sec is a theoretical limit; 1,000° C./sec is a technical limit; and 100° C./sec is a practical limit. Additionally, the cooling rate is a value obtained by dividing a difference between a temperature at which cooling is started and a final cooling temperature by a time of from the start of cooling to the arrival at the final cooling temperature. Furthermore, when the resulting mixture is further heated to a temperature of from 0 to 200° C. (preferably from 0 to 150° C., more preferably from 0 to 120° C., most preferably from 0 to 50° C.), a solution having the polymer flown in the organic solvent is formed. The temperature rise may be achieved by merely allowing the mixture to stand at room temperature or by heating in a warm bath.

A uniform solution is thus obtained in the foregoing manner. Additionally, in the case where the dissolution is insufficient, the cooling or heating operation may be repeated. Whether or not the dissolution is sufficient can be judged merely by visual observation of the appearance of the solution. In the cooling dissolution method, in order to avoid incorporation of moisture due to dew condensation upon cooling, it is desirable to use a sealed vessel. Also, in the cooling or heating operation, when pressurization is carried out upon cooling and evacuation is carried out upon heating, the dissolution time can be shortened. In order to carry out the pressurization or evacuation, it is desirable to use a pressure vessel.

Additionally, differential scanning calorimetry (DSC) reveals that, in a 20% by weight solution obtained by dissolving a cellulose acetate (acetylation degree: 60.9%; viscosity average polymerization degree: 299) in methyl acetate by a cooling dissolution method, a pseudo-phase transition point between a sol state and a gel state exists in the vicinity of 33° C., and the solution acquires a uniform gel state at a temperature of no higher than this temperature. Accordingly, this solution is required to be stored at a temperature of the pseudo-phase transition temperature or higher, preferably a temperature of about 10° C. higher than the gel phase transition temperature. However, this pseudo-phase transition temperature varies depending upon the acylation degree and viscosity average polymerization degree of the cellulose acetate, the solution concentration, and kind of the organic solvent to be used.

A polymer film is produced from the prepared polymer solution (dope) by a solvent casting method. Also, it is preferred to add the foregoing retardation increasing agent to the dope.

The dope is cast on a drum or a band, and the solvent is vaporized to form a film. The concentration of the dope before casting is preferably adjusted in the range of from 10 to 40%, more preferably from 15 to 35% in terms of content of solids. The surface of the drum or band is preferably mirror-finished. The casting and drying method in the solvent casting method is described in U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, U.K. Patent No. 640,731, U.K. Patent No. 736,892, JP-B-45-4554, JP-B-49-5614, JP-A-60-176834, JP-A-60-203430, and JP-A-62-115035. The dope is preferably cast on a drum or a band having a surface temperature of not higher than 40° C. It is preferred that, after casting, air is blown for 2 seconds or more to achieve drying. The resulting film is stripped off from the drum or band and further dried by a high-temperature air while successively changing the temperature from 100° C. to 160° C., whereby the residual solvent can be evaporated. The foregoing method is described in JP-B-5-17844. According to this method, it is possible to shorten a time of from casting to stripping-off. In order to perform this method, it is necessary that the dope is gelled at the surface temperature of the drum or band upon casting.

Plural polymer solutions may be cast. In the case of casting plural polymer solutions, a film can be prepared while casting each polymer-containing solution through plural casting nozzles provided at intervals in the movement direction of the support and stacking (methods described in, for example, see JP-A-61-158414, JP-A-1-122419, and JP-A-11-198285). Also, the formation of a film can also be carried out by casting the polymer solutions through two casting nozzles (methods described in, for example, see JP-B-60-27562, JP-A-61-94724, JP-A-61-94725, JP-A-61-104813, JP-A-61-158413, and JP-A-6-134933). Furthermore, a polymer film casting method in which a flow of a high-viscosity polymer solution is encompassed by a low-viscosity polymer solution, and the high-viscosity and low-viscosity polymer solutions are simultaneously extruded (JP-A-56-162617) can also be employed.

A method in which a film is prepared by using two casting nozzles, stripping off a film formed on a support by a first casting nozzle and then subjecting the side of the film having been in contact with the support surface to second casting can also be carried out (a method described in JP-B-44-20235). With respect to the plural polymer solutions, the same solution may be used. For the purpose of making plural polymer layers have a different function, a polymer solution corresponding to each function may be extruded through each casting nozzle.

The polymer solution can be cast simultaneously with other functional layers (for example, an adhesive layer, a dye layer, an antistatic layer, an anti-halation layer, an ultraviolet ray absorbing layer, and a polarizing layer).

With conventional single-layer solutions, in order to form a film with a necessary thickness, it is required to extrude a high-viscosity polymer solution with a high concentration. In that case, there has often been encountered a problem that the stability of the polymer solution is so poor that solids are generated, thereby causing a spitting fault or inferiority in flatness. As a method for solving this problem, high-viscosity solutions can be extruded onto the support at the same time by casting plural polymer solutions through casting nozzles, whereby a film having improved flatness and excellent surface properties can be prepared. Furthermore, by using concentrated polymer solutions, a reduction of a drying load can be achieved, and the production speed of the film can be accelerated.

In order to improve the mechanical physical properties or increase the drying speed, a plasticizer can be added. As the plasticizer, a phosphoric ester or a carboxylic acid ester is used. Examples of the phosphoric ester include triphenyl phosphate (TPP) and tricresyl phosphate (TCP). As the carboxylic acid, a phthalic ester and a citric ester are representative. Examples of the phthalic ester include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citric ester include triethyl O-acetylcitrate (OACTE) and tributyl O-acetylcitrate (OACTB). Examples of other carboxylic acid esters include butyl oleate, methylacetyl ricinolate, dibutyl sebacate, and various trimellitic esters. Phthalic ester based plasticizers (for example, DMP, DEP, DBP, DOP, DPP, and DEHP) are preferably used, with DEP and DPP being especially preferred.

The addition amount of the plasticizer is preferably from 0.1 to 25% by weight, more preferably from 1 to 20% by weight, most preferably from 3 to 15% by weight, based on the amount of the polymer.

In the polymer film, a deterioration preventive agent (for example, an antioxidant, a peroxide decomposing agent, a radical inhibitor, a metal inactivating agent, an acid scavenger, and an amine) may be added. The deterioration preventive agent is described in JP-A-3-199201, JP-A-5-197073, JP-A-5-194789, JP-A-5-271471, and JP-A-6-107854. The addition amount of the deterioration preventive agent is preferably from 0.01 to 1% by weight, more preferably from 0.01 to 0.2% by weight, based on the weight of the solution (dope) to be prepared. When the addition amount is not less than 0.01% by weight, an effect by the deterioration preventive agent is exhibited. On the other hand, when the addition amount does not exceed 1% by weight, there may not be the case where bleed-out of the deterioration preventive agent onto the film surface is observed. Examples of the deterioration preventive agent which is especially preferred include butylated hydroxytoluene (BHT) and tribenzylamine (TBA).

With the prepared polymer film, the retardation can be further adjusted by a stretching treatment. The stretch ratio is preferably from 3 to 100%. The thickness of the polymer film after stretching is preferably from 20 to 200 μm, more preferably from 30 to 100 μm. By adjusting the condition of the stretching treatment, it is possible to minimize a standard deviation of the slow axis angle of the optical compensatory sheet. The stretching treatment can be carried out using a tenter. In subjecting the film prepared by the solvent casting method to transverse stretching using a tenter, it is possible to minimize a standard deviation of the slow axis angle of the film by controlling the state of the film after stretching. Specifically, the stretching treatment for adjusting the retardation value using a tenter is performed and, by holding the polymer film immediately after stretching at a temperature in the vicinity of the glass transition temperature of the film at a stretch ratio of from a maximum stretch ratio to a stretch ratio of 1/2 of the maximum stretch ratio, it is possible to minimize the standard deviation of the slow axis angle. When this holding is performed with the film temperature being lower than the glass transition temperature, the standard deviation becomes large.

Also, in carrying out longitudinal stretch between rolls, it is also possible to minimize the standard deviation of the slow axis angle by widening a distance between the rolls.

In the case where the polymer film is made to function as a transparent protective film for the polarizing film in addition to the function as a transparent support of the optical compensatory sheet, it is preferred that the polymer film is subjected to a surface treatment.

The surface treatment is carried out by a corona discharge treatment, a glow discharge treatment, a flame treatment, an acid treatment, an alkali treatment or an ultraviolet ray irradiation treatment. Of these, an acid treatment or an alkali treatment is preferred, with an alkali treatment being more preferred. In the case where the polymer is cellulose acetate, the acid treatment or alkali treatment is carried out as a saponification treatment against the cellulose acetate.

### (Second Optically Anisotropic Layer)

In addition to the stretched polymer film as mentioned above, the optical compensatory sheet may have a second optically anisotropic layer formed on a transparent support and formed from a low-molecular or high-molecular liquid crystalline compound in order to realize optical compensating function.

The second optically anisotropic layer is preferably formed from a liquid crystal composition, and it is preferred to be formed from a liquid crystal composition containing at least one kind of discotic liquid crystal compounds. As such discotic liquid crystal compound, compounds represented by the following formula (DI) are preferred. These are preferred because they show high birefringence properties. Among the compounds represented by the following general (DI), those compounds are preferred which show discotic liquid crystal properties, with those which show a discotic-nematic phase being particularly preferred.

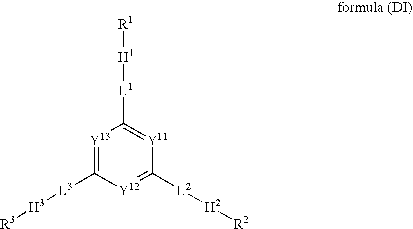

In the formula (DI), Y¹¹, Y¹² and Y¹³ each independently represents a methine group or a nitrogen atom; L¹, L² and L³ each independently represents a single bond or a divalent linking group; H¹, H² and H³ each independently represents formula (DI-A) or (DI-B) shown below; and R¹, R² and R³ each independently represents formula (DI-R) shown below.

In formula (DI), Y¹¹, Y¹² and Y¹³ each independently represents a methine group or a nitrogen atom. When each of Y¹¹, Y¹² and Y¹³ is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Of those, preferred are an alkyl group, an alkoxy group, an alkoxycarbonyl group, an acyloxy group, a halogen atom and a cyano group; more preferred are an alkyl group having from 1 to 12 carbon atoms (the number being number of carbon atoms which the substituent has; the same applies to substituents which the discotic liquid crystal compound may have), an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups.

In formula (DI), L¹, L² and L³ each independently represents a single bond or a divalent linking group. The divalent linking group is preferably a divalent linking group selected from —O—, —S—, —C(═O)—, —NR⁷—, —CH═CH—, —C≡C—, a divalent cyclic group, and their combinations. R⁷ represents an alkyl group having from 1 to 7 carbon atoms or a hydrogen atom, preferably an alkyl group having from 1 to 4 carbon atoms or a hydrogen atom, more preferably a methyl group, an ethyl group or a hydrogen atom, particularly preferably a hydrogen atom.

The divalent cyclic group represented by L¹, L² or L³ is preferably a 5-membered, 6-membered or 7-membered ring group, more preferably a 5-membered or 6-membered ring group, still more preferably a 6-membered ring group. The ring contained in the cyclic group may be a condensed ring. However, a monocyclic ring is more preferred than a condensed ring. The ring in the cyclic ring may be any of an aromatic ring, an aliphatic ring, and a hetero ring. Examples of the aromatic ring include a benzene ring and a naphthalene ring. An example of the aliphatic ring is a cyclohexane ring. Examples of the hetero ring include a pyridine ring and a pyrimidine ring. Preferably, the cyclic group contains an aromatic ring or a hetero ring.

Of the divalent cyclic group, the benzene ring-having cyclic group is preferably a 1,4-phenylene group. The naphthalene ring-having cyclic group is preferably a naphthalene-1,5-diyl group or a naphthalene-2,6-diyl group. The cyclohexane ring-having cyclic group is preferably a 1,4-cyclohexylene group. The pyridine ring-having cyclic group is preferably a pyridine-2,5-diyl group. The pyrimidine ring-having cyclic group is preferably a pyrimidine-2,5-diyl group.

The divalent cyclic group represented by L¹, L² or L³ may have a substituent. Examples of the substituent include a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted with an alkyl group having from 2 to 16 carbon atoms, and an acylamino group having from 2 to 16 carbon atoms.

L¹, L² and L³ are preferably a single bond, *—O—CO—, *—CO—O—, *—CH═CH—, *—C≡C—, *-divalent cyclic group-, *—O—CO-divalent cyclic group-, *—CO—O-divalent cyclic group-, *—CH═CH-divalent cyclic group-, *—C—C-divalent cyclic group-, *-divalent cyclic group-O—CO—, *-divalent cyclic group-CO—O—, *-divalent cyclic group-CH═CH—, or *-divalent cyclic group-C≡C—. Particularly preferably, they are a single bond, *—CH═CH—, *—C═C—, *—CH≡CH-divalent cyclic group- or *—C≡C-divalent cyclic group-, still more preferably a single bond. In the examples, “*” indicates the position at which the group bonds to the 6-membered ring of formula (DI) that contains Y¹¹, Y¹² and Y¹³.

In formula (DI), H¹, H² and H³ each independently represents the following formula (DI-A) or (DI-B):

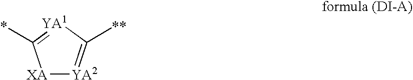

In formula (DI-A), YA¹ and YA² each independently represents a methine group or a nitrogen atom. Preferably, at least one of YA¹ and YA² is a nitrogen atom, more preferably they are both nitrogen atoms. XA represents an oxygen atom, a sulfur atom, a methylene group or an imino group. XA is preferably an oxygen atom. It is to be noted that * indicates the position at which the formula bonds to any of L¹ to L³; and ** indicates the position at which the formula bonds to any of R¹ to R³.

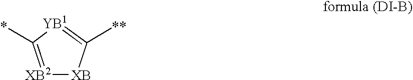

In formula (DI-B), YB¹ and YB² each independently represents a methine group or a nitrogen atom. Preferably, at least one of YB¹ and YB² is a nitrogen atom, more preferably they are both nitrogen atoms. XB represents an oxygen atom, a sulfur atom, a methylene group or an imino group. XB is preferably an oxygen atom. * indicates the position at which the formula bonds to any of L¹ to L³; and ** indicates the position at which the formula bonds to any of R¹ to R³.

R¹, R² and R³ each independently represents the following formula (DI-R):

*-(-L²¹-F¹)ₙ₁-L²²-L²³-Q¹ formula (DI-R)

In formula (DI-R), * indicates the position at which the formula bonds to H¹, H² or H³ in formula (DI). F¹ represents a divalent linking group having at least one cyclic structure. L²¹ represents a single bond or a divalent linking group. When L²¹ is a divalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms or a hydrogen atom, preferably an alkyl group having from 1 to 4 carbon atoms or a hydrogen atom, more preferably a methyl group, an ethyl group or a hydrogen atom, still more preferably a hydrogen atom.

L²¹ is preferably a single bond, **—O—CO—, **—CO—O—, **—CH═CH— or **—C≡C— (in which ** indicates the left side of L²¹ in formula (DI-R)). More preferably, it is a single bond.

In the formula (DI-R), F¹ represents a divalent linking group having at least one cyclic structure. The cyclic structure is preferably a 5-membered ring, a 6-membered ring, or a 7-membered ring, more preferably a 5-membered ring or a 6-membered ring, still more preferably a 6-membered ring. The cyclic structure may be a condensed ring. However, a monocyclic ring is more preferred than a condensed ring. The ring in the cyclic group may be any of an aromatic ring, an aliphatic ring and a hetero ring. Examples of the aromatic ring include a benzene ring, a naphthalene ring, an anthracene ring, and a phenanthrene ring. An example of the aliphatic ring is a cyclohexane ring. Examples of the hetero ring include a pyridine ring and a pyrimidine ring.

Preferred examples of F¹ include benzene ring-having groups such as a 1,4-phenylene group and 1,3-phenylene group; naphthalene ring-having groups such as a naphthalene-1,4-diyl group, a naphthalene-1,5-diyl group, a naphthalene-1,6-diyl group, a naphthalene-2,5-diyl group, a naphthalene-2,6-diyl group, and a naphthalene-2,7-diyl group; cyclohexane ring-having groups such as a 1,4-cyclohexylene group; pyridine ring-having groups such as a pyridine-2,5-diyl group; and pyrimidine ring-having groups such as a pyrimidin-2,5-diyl group. F¹ particularly preferably represents a 1,4-phenylene group, a 1,3-phenylend group, a naphthalene-2,6-diyl group or a 1,4-cyclohexylene group.

F¹ may have a substituent. Examples of the substituent include a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted with an alkyl group having from 2 to 16 carbon atoms, and an acylamino group having from 2 to 16 carbon atoms. Preferred examples of the substituent include a halogen atom, a cyano group, an alkyl group having from 1 to 6 carbon atoms, and a halogen atom-substituted alkyl group having from 1 to 6 carbon atoms; more preferred examples include a halogen atom, an alkyl group having from 1 to 4 carbon atoms, and a halogen atom-substituted alkyl group having from 1 to 4 carbon atoms; particularly preferred examples include a halogen atom, an alkyl group having from 1 to 3 carbon atoms, and a trifluoromethyl group.

n1 represents an integer of from 0 to 4. n1 is preferably an integer of from 1 to 3, more preferably 1 or 2. In the case where n1 is 0, L²² in formula (DI-R) directly links to any of H¹ to H³. In the case where n1 is 2 or more, plural -L²¹-F¹ may be the same or different from each other.

L²² represents —O—, —O—CO—, —CO—O—, —O—CO—O—, —S—, —NH—, —SO₂—, —CH₂—, —CH═CH— or —C≡C—, preferably —O—, —O—CO—, —CO—O—, —O—CO—O—, —CH₂—, —CH═CH— or —C≡C—, and more preferably —O—, —O—CO—, —CO—O—, —O—CO—O— or —CH₂—.

When the above-mentioned groups have one or more hydrogen atoms, the hydrogen atom(s) may be substituted with one or more substituents. Examples of the substituent include a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, a carbamoyl group substituted with an alkyl group having from 2 to 6 carbon atoms, and an acylamino group having from 2 to 6 carbon atoms. Especially preferred are a halogen atom and an alkyl group having from 1 to 6 carbon atoms.

L²³ represents a divalent linking group selected from —O—, —S—, —C(═O)—, —SO₂—, —NH—, —CH₂—, —CH═CH—, —C≡C—, and a group formed by linking two or more of these. The hydrogen atom in —NH—, —CH₂—, and —CH═CH— may be substituted with any other substituent. Examples of the other substituent include a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, a carbamoyl group substituted with an alkyl group having from 2 to 6 carbon atoms, and an acylamino group having from 2 to 6 carbon atoms. Especially preferred are a halogen atom and an alkyl group having from 1 to 6 carbon atoms. Substitution with these substituents serves to improve solubility of the compounds represented by the foregoing formula (DI), thereby the composition of the invention being able to be readily prepared as a coating solution.

L²³ is preferably a linking group selected from the group consisting of —O—, —C(═O)—, —CH₂—, —CH═CH—, —C≡C—, and a combination of these groups. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

Q¹ represents a polymerizable group or a hydrogen atom. In the case where the compound represented by the formula (DI) is to be used for preparing an optical film or the like such as an optical compensatory film that is required not to undergo change in retardation magnitude due to heat, Q¹ is preferably a polymerizable group. The polymerization reaction is preferably addition polymerization (including ring-cleavage polymerization) or polycondensation. In other words, the polymerizable group preferably is a functional group that enables addition polymerization reaction or polycondensation reaction. Examples of the polymerizable group are shown below.

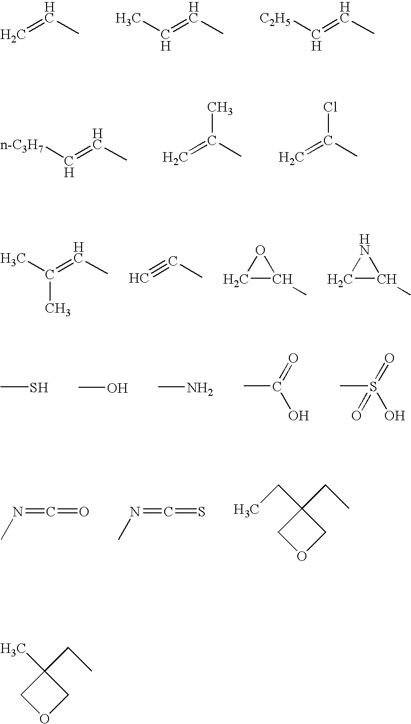

Further, the polymerizable group is particularly preferably functional group enabling addition polymerization reaction. The polymerizable group of the type is preferably a polymerizable ethylenically unsaturated group or a ring-cleavage polymerizable group.

Examples of the polymerizable ethylenically unsaturated group are the groups represented by the following formulae (M-1) to (M-6):

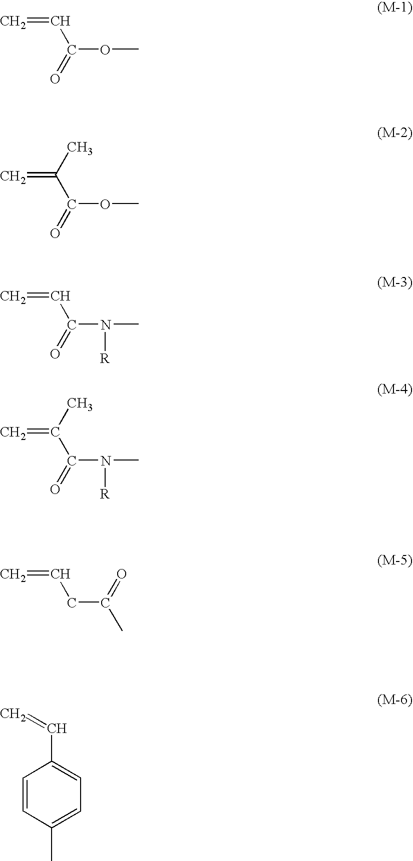

In formulae (M-3) and (M-4), R represents a hydrogen atom or an alkyl group. R is preferably a hydrogen atom or a methyl group. Of formulae (M-1) to (M-6), preferred are formulae (M-1) and (M-2), and more preferred is formula (M-1).

The ring-cleavage polymerizable group is preferably a cyclic ether group, more preferably an epoxy group or an oxetanyl group, most preferably an epoxy group.

Also, in the invention, use of the compound represented by the following formula (DII) or the compound represented by the following formula (DIII) as a discotic liquid crystal compound is preferred as well.

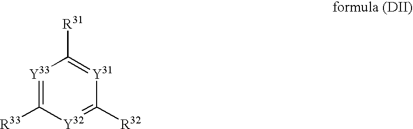

In formula (DII), Y³¹, Y³², and Y³³ each independently represents a methine group or a nitrogen atom; and R³¹, R³², and R³³ each independently represents formula (DII-R) shown below.

In formula (DII), Y³¹, Y³², and Y³³ have the same meaning as that of Y¹¹, Y¹², and Y¹³ in formula (DI), and their preferred range is also the same as described therein.

R³¹, R³², and R³³ each independently represents a group of the following formula (DII-R):

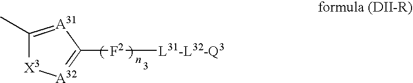

In formula (DII-R), A³¹ and A³² each independently represents a methine group or a nitrogen atom. Preferably, at least one of A³¹ and A³² is a nitrogen atom; more preferably the two are both nitrogen atoms.

X³ represents an oxygen atom, a sulfur atom, a methylene group or an imino group. Preferably, X³ is an oxygen atom.

In formula (DII-R), F² represents a divalent cyclic linking group having a 6-membered cyclic structure. The 6-membered ring contained in F² may be a condensed ring. However, a monocyclic ring is more preferred than a condensed ring. The 6-membered ring contained in F² may be any of an aromatic ring, an aliphatic ring, and a hetero ring.

Examples of the aromatic ring include a benzene ring, a naphthalene ring, an anthracene ring, and a phenanthrene ring. An example of the aliphatic ring is a cyclohexane ring. Examples of the hetero ring include a pyridine ring and a pyrimidine ring.

Preferred examples of the divalent cyclic group include benzene ring-having groups such as a 1,4-phenylene group and a 1,3-phenylene group; naphthalene ring-having groups such as a naphthalene-1,4-diyl group, a naphthalene-1,5-diyl group, a naphthalene-2,5-diyl group, a naphthalene-2,6-diyl group, and a naphthalene-2,7-diyl group; cyclohexane ring-having groups such as a 1,4-cyclohexylene group; pyridine ring-having groups such as a pyridine-2,5-diyl group; and pyrimidine ring-having groups such as a pyrimidin-2,5-diyl group. Particularly preferably, the divalent cyclic group is a 1,4-phenylene group, a 1,3-phenylene group, a naphthalene-2,6-diyl group or a 1,4-cyclohexylene group.

F² may have a substituent or substituents. Examples of the substituent include a halogen atom (e.g., fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted by an alkyl group having from 2 to 16 carbon atoms, and an acylamino group having from 2 to 16 carbon atoms. The substituent of the divalent cyclic group is preferably a halogen atom, a cyano group, an alkyl group having from 1 to 6 carbon atoms, or a halogen atom-substituted alkyl group having from 1 to 6 carbon atoms, more preferably a halogen atom, an alkyl group having from 1 to 4 carbon atoms, or a halogen atom-substituted alkyl group having from 1 to 4 carbon atoms, still more preferably a halogen atom, an alkyl group having from 1 to 3 carbon atoms, or a trifluoromethyl group.

n³ represents an integer of from 1 to 3. n³ is preferably 1 or 2. When n³ is 2 or more, plural F² may be the same or different from each other.

L³¹ represents —O—, —O—CO—, —CO—O—, —O—CO—O—, —S—, —NH—, —SO₂—, —CH₂—, —CH═CH— or —C≡C— and, when the above-mentioned group contains a hydrogen atom, the hydrogen atom may be replaced by a substituent. The preferred range of L³¹ may be the same as that of L²² in formula (DI-R).

L³² represents a divalent linking group selected from —O—, —S—, —C(═O)—, —SO₂—, —NH—, —CH₂—, —CH═CH—, —C≡C—, and a group formed by linking two or more of these and, when the group has a hydrogen atom, the hydrogen atom may be substituted with a substituent. The preferred range of L³² is the same as that of L²³ in formula (DI-R).

Q³ represents a polymerizable group or a hydrogen atom, and the preferred range thereof is the same as that of Q¹ in formula (DI-R).

Compounds of formula (DIII) will be described in detail below.

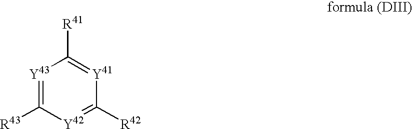

In formula (DIII), Y⁴¹, Y⁴², and Y⁴³ each independently represents a methine group or a nitrogen atom. When Y⁴¹, Y⁴², and Y⁴³ each is a methine group, the hydrogen atom of the methine group may be substituted with a substituent. Preferred examples of the substituent that the methine group may have are an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Of these substituents, more preferred are an alkyl group, an alkoxy group, an alkoxycarbonyl group, an acyloxy group, a halogen atom, and a cyano group; still more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom, and a cyano group.

Preferably, Y⁴¹, Y⁴², and Y⁴³ are all methine groups, more preferably non-substituted methine groups.

R⁴¹, R⁴², and R⁴³ each independently represents formula (DIII-A), (DIII-B) or (DIII-C) shown below.

When a retardation plate having a small wavelength dispersion is to be prepared, R⁴¹, R⁴², and R⁴³ are preferably those which are represented by formula (DIII-A) to (DIII-C), more preferably those which are represented by formula (DIII-A).

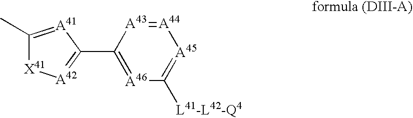

In formula (DIII-A), A⁴¹, A⁴², A⁴³, A⁴⁴, A⁴⁵, and A⁴⁶ each independently represents a methine group or a nitrogen atom. Preferably, at least one of A⁴¹ and A⁴² is a nitrogen atom; more preferably, the two are both nitrogen atoms. Preferably, at least three of A⁴³, A⁴4, A⁴⁵, and A⁴⁶ are methine groups; more preferably, all of them are methine groups. When A⁴³, A⁴4, A⁴⁵, and A⁴⁶ are methine groups, the hydrogen atom of the methine group may be substituted with a substituent. Examples of the substituent that the methine group may have are a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted with an alkyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms, and a halogen-substituted alkyl group having from 1 to 4 carbon atoms; still more preferred are a halogen atom, an alkyl group having from 1 to 3 carbon atoms, and a trifluoromethyl group.

X⁴¹ represents an oxygen atom, a sulfur atom, a methylene group or an imino group, with an oxygen atom being preferred.

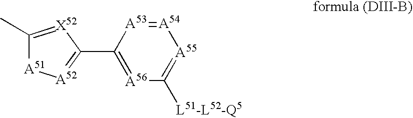

In formula (DIII-B), A⁵¹, A⁵², A⁵³, A⁵⁴, A⁵⁵, and A⁵⁶ each independently represents a methine group or a nitrogen atom. Preferably, at least one of A⁵¹ and A⁵² is a nitrogen atom; more preferably the two are both nitrogen atoms. Preferably, at least three of A⁵³, A⁵⁴, A⁵⁵, and A⁵⁶ are methine groups; more preferably, all of them are methine groups. When A⁵³, A⁵4, A⁵⁵, and A⁵⁶ are methine groups, the hydrogen atom of the methine group may be substituted with a substituent. Examples of the substituent that the methine group may have include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted with an alkyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms, and a halogen-substituted alkyl group having from 1 to 4 carbon atoms; still more preferred are a halogen atom, an alkyl group having from 1 to 3 carbon atoms, and a trifluoromethyl group.

X⁵² represents an oxygen atom, a sulfur atom, a methylene group or an imino group, with an oxygen atom being more preferred.

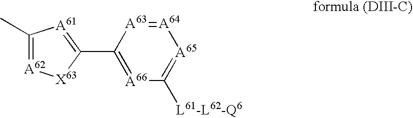

In formula (DIII-C), A⁶¹, A⁶², A⁶³, A⁶⁴, A⁶⁵, and A⁶⁶ each independently represents a methine group or a nitrogen atom. Preferably, at least one of A⁶¹ and A⁶² is a nitrogen atom; more preferably the two are both nitrogen atoms. Preferably, at least three of A⁶³, A⁶⁴, A⁶⁵, and A⁶⁶ are methine groups; more preferably, all of them are methine groups. When A⁶³, A64, A⁶⁵, and A⁶⁶ are methine groups, the hydrogen atom of the methine group may be substituted with a substituent. Examples of the substituent that the methine group may have include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted with an alkyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms and a halogen-substituted alkyl group having from 1 to 4 carbon atoms; still more preferred are a halogen atom, an alkyl group having from 1 to 3 carbon atoms, and a trifluoromethyl group.

X⁶³ represents an oxygen atom, a sulfur atom, a methylene group or an imino group, with an oxygen atom being preferred.

L⁴¹ in formula (DIII-A), L⁵¹ in formula (DIII-B), and L⁶¹ in formula (DIII-C) each independently represents —O—, —O—CO—, —CO—O—, —O—CO—O—, —S—, —NH—, —SO₂—, —CH₂—, —CH═CH— or —C≡C—; preferably —O—, —O——CO—, —CO—O—, —O—CO—O—, —CH₂—, —CH═CH— or —C≡C—; more preferably —O—, —O—CO—, —CO—O—, —O—CO—O— or —CH₂—. When the above-mentioned group has a hydrogen atom, then the hydrogen atom may be substituted with a substituent.

Preferred examples of the substituent include a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, a carbamoyl group substituted with an alkyl group having from 2 to 6 carbon atoms, and an acylamino group having from 2 to 6 carbon atoms. Especially preferred are a halogen atom and an alkyl group having from 1 to 6 carbon atoms.

L⁴² in formula (DIII-A), L⁵² in formula (DIII-B), and L⁶² in formula (DIII-C) each independently represents a divalent linking group selected from —O—, —S—, —C(═O)—, —SO₂—, —NH—, —CH₂—, —CH═CH—, —C≡C—, and a group formed by linking two or more of these. The hydrogen atom in —NH—, —CH₂— and —CH═CH— may be substituted with a substituent. Preferred examples of the substituent include a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, a carbamoyl group substituted with an alkyl group having from 2 to 6 carbon atoms, and an acylamino group having from 2 to 6 carbon atoms. More preferred are a halogen atom and an alkyl group having from 1 to 6 carbon atoms.

Preferably, L⁴², L⁵², and L⁶² each independently represents a divalent linking group selected from —O—, —C(═O)—, —CH₂—, —CH═CH—, —C≡C—, and a group formed by linking two or more of these. More preferably, L⁴², L⁵² and L⁶² each independently has from 1 to 20 carbon atoms, more preferably from 2 to 14 carbon atoms. Still more preferably, L⁴², L⁵² and L⁶² each independently has from 1 to 16 (—CH₂—)'s, yet more preferably from 2 to 12 (—CH₂—)'s.

Q⁴ in formula (DIII-A), Q⁵ in formula (DIII-B), and Q⁶ in formula (DIII-C) each independently represents a polymerizable group or a hydrogen atom. Their preferred ranges are the same as that of Q¹ in formula (DI-R).

Specific examples of the compounds of formulae (DI), (DII), and (DIII) are illustrated below which, however, do not limit the invention at all.

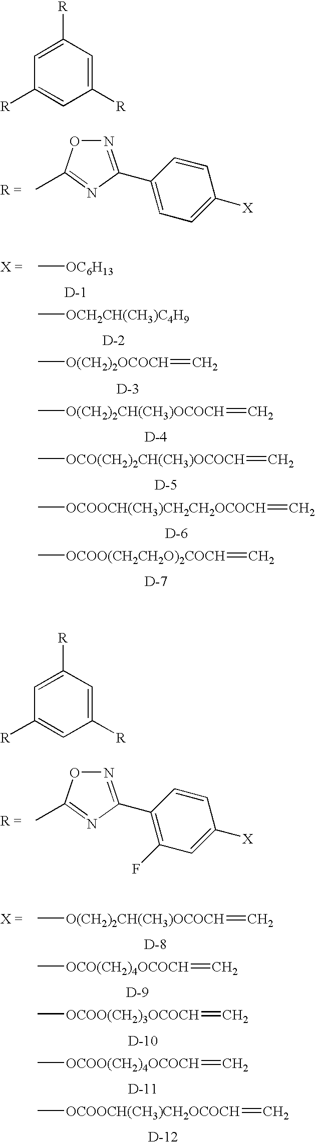

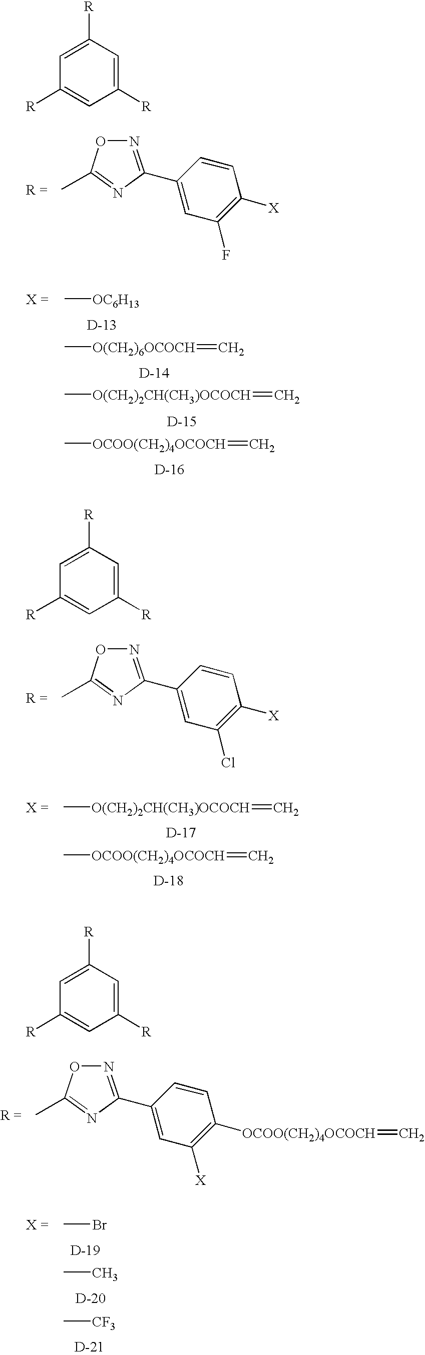

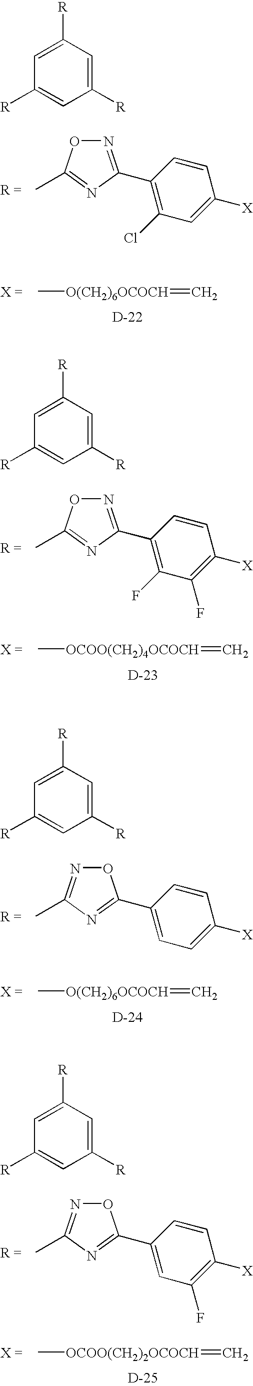

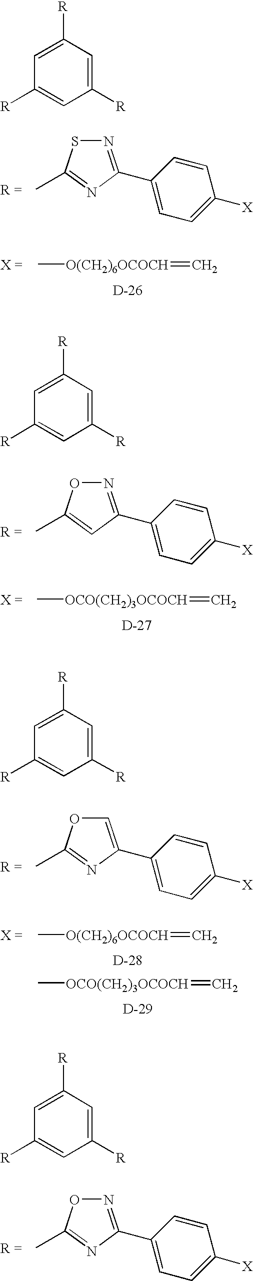

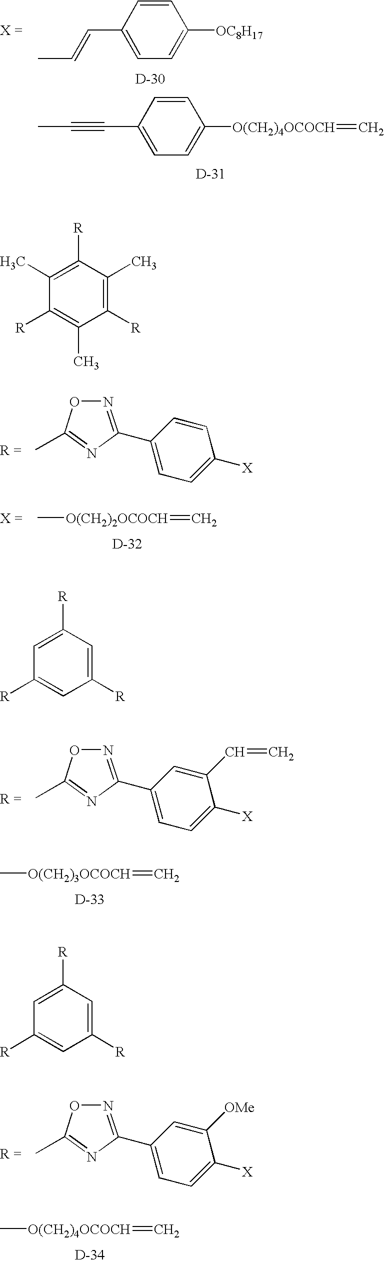

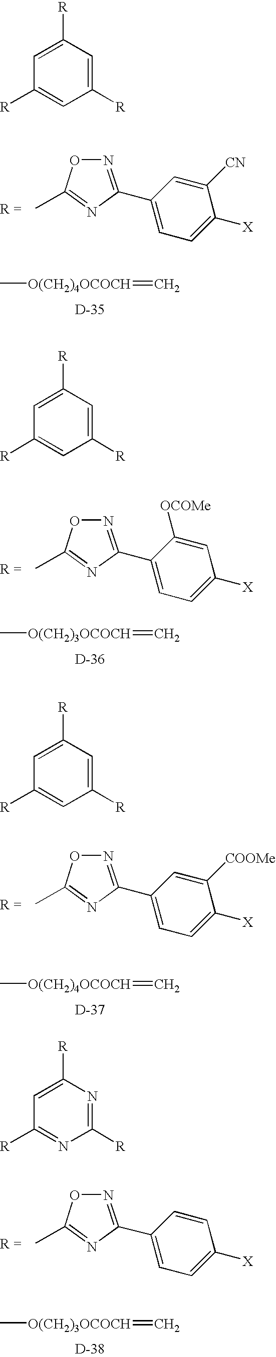

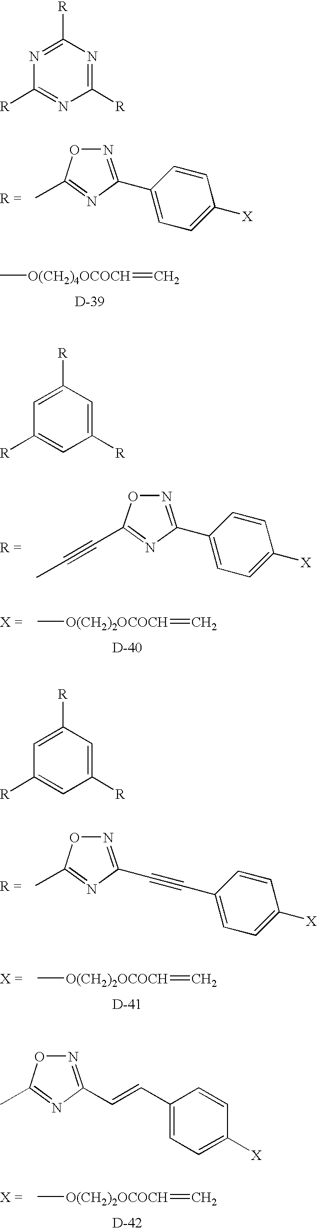

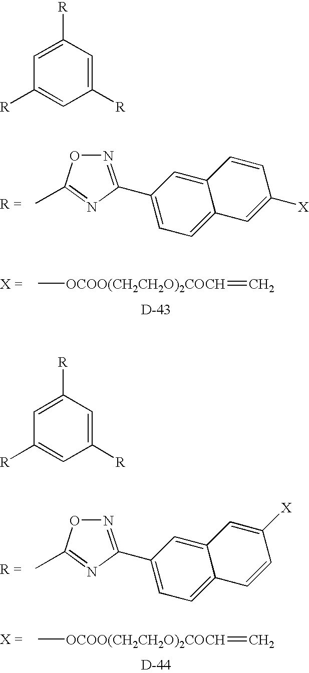

Examples of the compound represented by formula (DIII) are shown below.

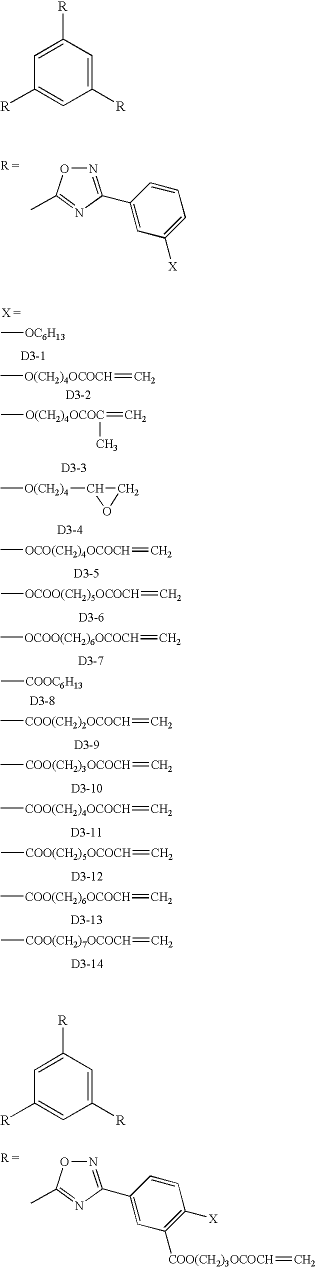

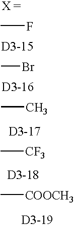

The compounds of the formulae (DI), (DII) and (DII) may be synthesized according to any known method.

According to the invention, as the discotic liquid crystal compound, only one kind of the compounds of the formulae (DI), (DII) and (DIII), or two or more thereof may be used.

Preferred examples of the discotic liquid crystal compound also include the compounds described in JP-A-2005-301206.

Preferably, the second optically anisotropic layer is prepared as follows. A composition containing at least one type of a liquid crystal compound is disposed on the surface of a polymer (e.g., the surface of an alignment film); and then the molecules of the liquid crystal compound are aligned in a desired alignment state. The compound is polymerized to cure thereby fixing the alignment state. The fixed alignment state is preferably a hybrid alignment state. The hybrid alignment means that the direction of the director of the liquid crystal molecules continuously changes in the thickness direction of the layer. With rod-shaped molecules, the director is in the direction of the major axis thereof; and, with discotic molecules, the director is any diameter of the discotic plane thereof.

In order that the molecules of a liquid crystal compound are aligned in a desired alignment state, and for the purpose of improving the coating properties or the curability of the composition, the composition may contain one or more additives.

For hybrid alignment of the molecules of a liquid crystal compound (especially a rod-shaped liquid crystal compound), an additive for controlling the alignment on the air interface side of the layer (hereinafter this may be referred to as “air-interface alignment controlling agent”) may be added. The additive includes a low-molecular-weight or high-molecular-weight compounds having a hydrophilic group such as a fluoroalkyl group or a sulfonyl group. Specific examples of the air-interface alignment controlling agent usable herein are described in JP-A-2006-267171.

Also, when the composition is prepared as a coating liquid and the second optically anisotropic layer is formed by coating it, a surfactant may be added thereto for improving the coating properties of the liquid. As the surfactant, a fluorine-containing compound is preferred, and specific examples thereof are those compounds which are described in JP-A-2001-330725, paragraphs [0028] to [0056]. Also, a commercial product, Megafac F780 (manufactured by Dai-Nippon Ink) may be used.

Preferably, the composition contains a polymerization initiator. The polymerization initiator may be either a thermal polymerization initiator or a photo-polymerization initiator; but preferred is a photo-polymerization initiator as it is easy to control. Examples of the photo-polymerization initiator capable of generating radicals under irradiation with light include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in JP-A-60-105667 and U.S. Pat. No. 4,239,850), oxadiazole compounds (those described in U.S. Pat. No. 4,212,970), acetophenone-type compounds, benzoin ether-type compounds, benzyl-type compounds, benzophenone-type compounds, and thioxanthone-type compounds. Examples of the acetophenone-type compounds include 2,2-diethoxy-acetophenone, 2-hydroxymethyl-1-phenylpropan-1-on, 4′-isopropyl-2-hydroxy-2-methyl-propiophenone, 2-hydroxy-2-methyl-propiophenone, p-dimethylamino-acetophenone, p-tert-butyl dichloroacetophenone, p-tert-butyl-trichloro acetophenone, and p-azidebenzalacetophenone. Examples of the benzyl-type compounds include benzyl, benzyl dimethyl ketal, benzyl-β-methoxyethyl acetal, and 1-hydroxycyclohexyl phenyl ketone. Examples of the benzoin ether compounds include benzoin, benzoin methyl ether, benzoin ethyl ether, benzoin n-propyl ether, benzoin isopropyl ether, benzoin n-butyl ether, and benzoin isobutyl ether. Examples of the benzophenone-type compounds include benzophenone, methyl o-benzoylbenzoate, Michler's ketone, 4,4′-bis-diethylaminobenzophenone, and 4,4′-dichlorobenzophenone. Examples of the thioxanthone-type compounds include thioxanthone, 2-methylthioxanthone, 2-ethylthioxanthone, 2-isopropylthioxanthone, 4-isopropylthioxanthone, 2-chlorothioxanthone, and 2,4-diethylthioxanthone. Among the photo-sensitive radical polymerization initiators composed of aromatic ketones, acetophenone-type compounds and benzyl-type compounds are preferred in view of curing properties, preservation stability, and odor. One or more initiators selected from these photo-sensitive radical polymerization initiators may be used depending on the desirable properties.

Also, for the purpose of enhancing the sensitivity, one or more sensitizers may be used in addition to the polymerization initiator. Examples of the sensitizer include n-butylamine, triethylamine, tri-n-butylphosphine and thioxanthone.

Two or more polymerization initiators may be used in combination thereof. The amount of the polymerization initiator in the coating liquid is preferably from 0.01 to 20% by weight, more preferably from 0.5 to 5% by weight, based on the weight of solid components of the coating liquid. Light irradiation for polymerization of the liquid crystal compound is preferably carried out with UV-light.

The composition may further contain a non-liquid-crystalline polymerizable monomer along with the polymerizable liquid crystal compound. Examples of the polymerizable monomer include any compounds that have a vinyl group, a vinyloxy group, an acryloyl group or a methacryloyl group. Additionally, poly-functional monomers having two or more polymerizable groups, such as ethylene oxide-modified trimethylolpropane acrylate are preferred, because they improve durability. The amount of the non-liquid-crystalline polymerizable monomer is 15% by weight or less, preferably from about 0 to about 10% by weight, based on the amount of the liquid crystal compound.

The second optically anisotropic layer may be prepared as follows. The composition is prepared as a coating liquid. The coating liquid is applied to, for example, a surface of an alignment layer formed on the support, and dried to remove the solvent therefrom with aligning the molecules of the liquid crystal compound in a desired state. Then, polymerization is carried out to cure, thus the second optically anisotropic layer being formed.

As the coating method, there are illustrated known coating methods such as a curtain coating method, a dip coating method, a spin-coating method, a printing coating method, a spray coating method, a slot coating method, a roll coating method, a slide coating method, a blade coating method, a gravure coating method, and a wire-bar coating method.

Drying of the coated layer may be carried out under heat. While the solvent in the coated layer is removed from the layer by drying, the molecules of the liquid crystal compound are aligned to obtain the desired alignment state.

Next, polymerization is carried out with irradiation of UV-light to fix the alignment, thus the second optically anisotropic layer being formed. In the photo-irradiation for polymerization, use of UV-light is preferred. The irradiation energy is preferably from 20 mJ/cm² to 50 J/cm², more preferably from 100 mJ/cm²to 800 mJ/cm². Irradiation may be carried out under heat to accelerate the photo-polymerization reaction.

The thickness of the second optically anisotropic layer is not particularly limited, and preferably from 0.1 to 10 μm, more preferably from 0.5 to 5 μm.

The second optically anisotropic layer is formed by using preferably an alignment layer. Examples of the usable alignment layer include polyvinyl alcohol films and polyimide films.

### [Color Tint of Black Display]

The color tint in the front direction depends on the polarizing film, but the color tint particularly from an oblique direction varies according to the wavelength dispersion of the optically anisotropic layer of the optical compensatory sheet and the wavelength dispersion of the liquid crystal used in the cell.

### (Wavelength Dispersion of Optical Compensatory Sheet)

With the optical compensatory sheet in the invention, Re(630) is preferably larger than Re(450). In particular, it is preferred that the first optically anisotropic layer has optical positive mono-axial or bi-axial properties and that the in-plane retardation Re(630) at a wavelength of 630 nm is larger than the in-plane retardation Re(450) at a wavelength of 450 nm. It is more preferred that the first optically anisotropic layer shows so-called reverse wavelength dependence of the dispersion to all visible lights. Here, the phrase “Re shows reverse wavelength dependence of the dispersion in the all visible light region” means that Re becomes larger as the wavelength of the incident light (visible light) is longer. Specifically, the first optically anisotropic layer preferably satisfies the following formula (A), more preferably satisfies the following formula (A)′.

5 nm≦ΔRe(630−450)≦45 nm (A)

5 nm≦ΔRe(630−450)≦35 nm (A)′

Additionally, ΔRe(λ₁−λ₂) means a difference between Re(λ₁) and Re(λ₂) (i.e. ΔRe(630−450) means a difference between Re(630) and Re(450)).

In one embodiment of the optical compensatory sheet in accordance with the invention, the first optically anisotropic layer is composed of a polymer film which satisfies the above-mentioned condition, and the second optically anisotropic layer is composed of an optically anisotropic layer containing a discotic liquid crystal compound fixed in a hybrid alignment state. In this embodiment, the polymer of the first optically anisotropic layer preferably satisfies the following formulae (B) and (C).

50 nm≦Re(550)≦140 nm (B)

0.5≦Rth(550)/Re(550)≦6.0 (C)

Further, the polymer more preferably satisfies the following formulae (B)′ and (C)′.

50 nm≦Re(550)≦120 nm (B)′

0.5≦Rth(550)/Re(550)≦5.0 (C)′

The polymer still more preferably satisfies the following formulae (B)″ and (C)″.

50 nm≦Re(550)≦100 nm (B)″

0.5≦Rth(550)/Re(550)≦5.0 (C)″

Further, the polymer film of the first optically anisotropic layer of the optical compensatory sheet in the invention preferably satisfies the following formula (D), more preferably satisfies the following formula (D)′.

ΔRth(630−450)≦30 nm (D)

ΔRth(630−450)≦5 nm (D)′

Additionally, ΔRth(λ₁−λ₂) means a difference between Rth(λ₁) and Rth(λ₂) (i.e. ΔRth(630−450) means a difference between Rth(630) and Rth(450)).

In the invention, optically compensating performance for a liquid crystal display device is improved, and a high contrast owing to reduction of black luminance is realized in a wider viewing angle range than with conventional devices, by utilizing the optically anisotropic layer having the above-mentioned properties as the first optically anisotropic layer.

However, in the optical compensatory sheet, to have the above-mentioned wavelength dispersion properties means to generate, at the same time, change in blue tint upon black display and change in yellow tint upon white display. In order to correct these color tint changes, the following light-scattering sheet is used in the invention.

### (Light-Scattering Sheet)

A light-scattering sheet is disposed on the outermost side (viewing side) of the display-side polarizing film. It is possible to provide an anti-reflection layer having anti-staining properties and scratch resistance on the outermost surface of the light-scattering sheet. As the anti-reflection layer, any of conventionally known ones may be used.

The light-scattering sheet of the invention is preferably a light-scattering sheet having a light-scattering sheet on a transparent support. It is sufficient for the light-scattering layer to have the function of scattering light. The light-scattering layer may have other functions, and an embodiment is preferred which has internal scattering properties and/or surface scattering properties (anti-glare properties) and has hardcoat properties. Also, the light-scattering sheet in accordance with the invention is preferably an anti-reflection sheet having, in addition to the light-scattering layer, an anti-reflection layer which reduces the reflectivity using the principle of optical interference. Additionally, in the following description, the light-scattering sheet includes the anti-reflection sheet of the above-mentioned constitution.

The light-scattering layer has preferably a light-transmitting resin and a light-scattering body dispersed in the light-transmitting resin and, in view of production, the light-scattering body is preferably light-transmitting particles. In the following description, only light-transmitting particles are particularly described as the light-scattering body, but the body is not limited only to them.

In order to enhance display quality (improve viewing angle) of an image display device by the light-scattering sheet, it is necessary to appropriately scatter an appropriately introduced light. As the scattering effect becomes larger, there results improved viewing angle characteristics. On the other hand, in order to maintain brightness in the front direction, it is necessary to increase the transmittance as much as possible in view of display quality.

### (Scattering Characteristics of Light-Scattering Sheet)

The appropriate scattering property can be specified by a haze value and scattering profile. If the haze value is too low, a satisfactory effect of improving the viewing angle cannot be obtained whereas, if the haze value is excessively high, brightness in the front direction decreases. Accordingly, the haze value of the light-scattering film is preferably from 30 to 90%, more preferably from 35 to 80%, still more preferably from 40 to 65%.

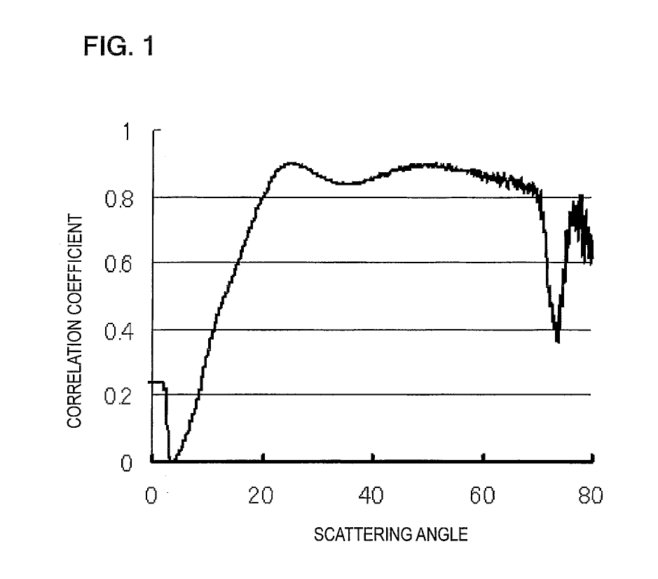

A preferred scattering profile of the light-scattering sheet in the invention is described below. As a result of investigation on optical characteristics including the optical compensatory sheet, it has been found that the reduction rate of the contrast of the display device in the front direction is strongly related to the light-scattering intensity in the direction inclined from the direction vertical to the light-scattering sheet by 26° (FIG. 1). That is, the lower the intensity of the scattered light in the direction inclined from the direction vertical to the light-scattering sheet by 26°, the higher the contrast in the front direction. Therefore, with the light-scattering sheet of the invention, I26/I0 (wherein I0 represents the amount of transmitted light entering from the vertical direction, and I26 represents the amount of scattered light in the direction of 26°) is in the range of preferably from 0.0005 to 0.0015, more preferably from 0.0005 to 0.0012, particularly preferably from 0.0007 to 0.0009. When the ratio exceeds the upper limit of the range, the amount of scattered light becomes so large that the reduction of the contrast in the front direction becomes serious, thus superiority upon mounting on a display device showing a low black luminance being reduced. Also, when the ratio is less than the lower limit of the range, the amount of scattered light becomes small, thus the tint-correcting effect being insufficient in some cases.

With conventional scattering films, as is seen in JP-A-2008-83294, scattering in the wide direction of 60° or more has served to suppress reduction of luminance in the front direction. In contrast, the invention is directed to a liquid crystal display device showing a low black luminance, and is excellent in the effect of suppressing the reduction of contrast in the front direction due to reduction of black luminance. That is, with a display device showing a low black luminance value in the angle direction isolated from the front direction, the amount of light itself distributed from the wide angle side to the front direction by the light-scattering effect of the light-scattering sheet reduces. Therefore, in order to suppress reduction of the contrast in the front direction, a scattering profile designed in consideration of the black display state is necessary. Accordingly, conventional light-scattering profile design of the light-scattering sheet fails to provide sufficient effects.

The design that 26°-direction scattering specifically exhibits the effect of suppressing reduction in the contrast in the front direction is absolutely different from the conventional design concept, thus not being thought of with ease.

As an apparatus for measuring scattering profile, there can be used, for example, “Gonio Photometer” (manufactured by Murakami Color Research Laboratory Co., Ltd.

### (Particle Size of Scattering Body of Light-Scattering Sheet)

In the present invention, for obtaining appropriate scattering properties, the particle size of the light-scattering particle is preferably from 0.5 to 6.0 μm, more preferably from 0.6 to 5.0 μm, and most preferably from 0.7 to 4.0 μm. By using particles having a particle size in this range, an angle distribution of light scattering suitable for the present invention is obtained. When the particle size is 0.5 μm or more, there does not result a large light-scattering effect, and viewing angle characteristics are not markedly improved. However, there does not result seriously reduced brightness due to large backward scattering. On the other hand, when the particle size is 6.0 μm or less, the light-scattering effect does not become small, thus viewing angle characteristics being more improved. In the invention, the shape of the light-scattering particles is not particularly limited and may take various shapes such as a spherical shape, a flat shape or a spindle-like shape, with spherical shape being preferred.

With the light-transmitting resin and the light-scattering body of the light-scattering layer, the refractive index of the light-transmitting resin (nB) is preferably lower than the refractive index of the light-transmitting particles (nP), and the difference in refractive index (Δn) is preferably from 0.03 to 0.20, particularly preferably from 0.04 to 0.18, still most preferably from 0.05 to 0.15. When the refractive index of the light-scattering layer is not too low, the difference in refractive index between the low refractive index layer and the light-scattering layer becomes big, resulting in improvement of anti-reflection properties. On the other hand, when the refractive index is not made too high, materials to be used are not restricted, leading not to high production cost and strong tint. Thus, such refractive index is preferred. Additionally, in the invention, the refractive index of the light-scattering layer is a value determined from the refractive index of the coated film containing solid components excluding the light-scattering body.

The light-transmitting particles are incorporated in a content of preferably from 3 to 30% by weight, more preferably from 3 to 25% by weight, still more preferably from 5 to 20% by weight, based on the total weight of all solid components in the light-scattering layer. When the content is not less than 3% by weight, the effect of the addition is sufficient. On the other hand, when the content does not exceed 30% by weight, the amount of scattered light does not become so much that there result serious increase of blurred image and serious reduction of contrast, thus the effect of the invention being achieved.

Also, the coating amount of the light-transmitting particles is preferably from 30 to 2,500 mg/m², more preferably from 100 to 2,400 mg/m², still more preferably from 600 to 2,300 mg/m², particularly preferably from 1,000 to 2,000 mg/m².

The average film thickness of the light-scattering layer is preferably from 2 to 30 μm, more preferably from 5 to 20 μm, still more preferably from 8 to 15 μm. When the thickness is not too small, there result sufficient hardcoat properties whereas, when the thickness is not too large, the curling or brittleness is not worsened and the processing suitability is less likely to decrease. Therefore, the film thickness is preferably in the above-described range. The average film thickness of the light-scattering layer is determined by enlarging the cross-sectional surface at a magnification of 5,000 times by an electron microscope, copying down the light-scattering layer by tracing paper (Se-TD58, 50 g/m²) manufactured by Kokuyo Co., Ltd., and measuring the weight.

The average film thickness of the light-scattering layer is from 1.4 to 3.5 times, preferably from 1.5 to 3.0 times, more preferably from 1.5 to 2.5 times, still more preferably from 1.6 to 2.0 times, the average particle size of the light-transmitting particles. When the average film thickness of the light-scattering layer is from 1.4 to 3.5 times the average particle size of the light-transmitting particles, the film thickness dependence or particle size dependence of the antiglare properties is reduced. Therefore, even when the film thickness is fluctuated due to steaks generated upon coating or due to drying unevenness, the surface state defect such as streaks or unevenness can be made less recognizable. The antiglare properties are preferably provided by surface irregularities resulting from protrusion ascribable to a three-dimensional steric structure which is formed by an aggregate of a plurality of particles, because even when slight change is generated in the film thickness or particle size, the size of surface irregularities is scarcely changed and the change of the antiglare properties are advantageously small. When the ratio of average film thickness/average particle size is too small, since the particles are present in one layer of the film, slight change in the film thickness or particle size causes a great change in the size of surface irregularities and, in turn, in the antiglare property, which is liable to worsen contrast. On the other hand, when the ratio is excessively large, a plurality of particles are distributed in the film in the layer direction, thus the scattering profile being changed and necessary scattering characteristics not being obtained. When the ratio of average film thickness/average particle size is from 1.4 to 3.5, the average particle size less fluctuates among particle lots and the fluctuation of antiglare properties of the film is reduced, so that a film with small lot-to-lot fluctuation can be obtained.

In the case of using the light-scattering film of the invention on the display surface, its pencil hardness is preferably high. The pencil hardness is preferably 2H or more, more preferably from 3H to 7H, still more preferably from 4H to 6H.

In the invention, it is possible to impart antiglare properties to the light-scattering film by forming unevenness on the film surface as needed. For obtaining a clear surface in order to maintain distinctness of an image, it is preferred to control characteristics showing the surface roughness, for example, the average center-line roughness (Ra) to 0.08 μm or less. Ra is more preferably 0.07 μm or less, still more preferably 0.06 μm or less.

The materials which can be used in the light-scattering layer of the invention are described below.

### [Light-Transmitting Resin]

The light-transmitting resin for use in the invention is not particularly limited as to the kind of its material, and a thermoplastic resin, a thermosetting resin or an ionizing radiation-curable resin may be appropriately used.

As the thermoplastic resin, various resins such as polyethylene terephthalate (PET), polyethylene naphthalate (PEN), polymethyl methacrylate (PMMA), polycarbonate (PC), polyethylene (PE), polypropylene (PP), polyvinyl alcohol (PVA), polyvinyl chloride (PVC), cycloolefin copolymer (COC), norbornene-containing resin, and polyether sulfone may be used.

Examples of the thermosetting resin include phenol resin, furan resin, xylene-formaldehyde resin, ketone-formaldehyde resin, urea resin, melamine resin, aniline resin, alkyd resin, unsaturated polyester resin, and epoxy resin. These may be used independently or as a mixture of a plurality of species thereof.

The ionizing radiation-curable resin is preferably a polyfunctional monomer or a polyfunctional oligomer in view of increase in the hardness of the cured film. The polymerizable functional group is preferably a photo-, electron beam- or radiation-polymerizable functional group, more preferably a photopolymerizable functional group.

Examples of the photopolymerizable functional group include an unsaturated polymerizable functional group such as a (meth)acryloyl group, a vinyl group, a styryl group, and an allyl group. Among these, a (meth)acryloyl group is preferred. Examples of the photopolymerizable monomer having two or more ethylenically unsaturated groups include an ester between polyhydric alcohol and (meth)acrylic acid (e.g., ethylene glycol di(meth)acrylate, 1,4-cyclohexanediol diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,3,5-cyclohexanetriol trimethacrylate, polyurethane polyacrylate, or polyester polyarylate), a vinylbenzene derivative (e.g., 1,4-divinylbenzene, 2-acryloylethyl 4-vinylbeozoate or 1,4-divinylcyclohexanone), a vinylsulfone (e.g., divinylsulfone), an acrylamide (e.g., methylenebisacrylamide), and a methacrylamide. Among these, an acrylate or methacrylate monomer having at least three functional groups is preferred, and an acrylate monomer having at least five functional groups is more preferred in view of film hardness, that is, scratch resistance. A mixture of dipentaerythritol pentaacrylate and dipentaerythritol hexaacrylate is commercially available and is particularly preferably used.

In place of the monomer having a polymerizable unsaturated group or in addition to the monomer having a polymerizable unsaturated group, a crosslinking functional group may be introduced into the binder. Examples of the crosslinking functional group include an isocyanate group, an epoxy group, an aziridine group, an oxazoline group, an aldehyde group, a carbonyl group, a hydrazine group, a carboxyl group, a methylol group, and an active methylene group. Also, a vinylsulfonic acid, an acid anhydride, a cyanoacrylate derivative, a melamine, an etherified methylol, an ester, a urethane, and a metal alkoxide such as tetramethoxysilane can be used as a monomer having a crosslinkable structure. A functional group which exhibits the crosslinking property as a result of decomposition reaction, such as blocked isocyanate group, may also be used. In other words, the crosslinking functional group for use in the invention may be a group which does not directly cause a reaction but exhibits reactivity as a result of decomposition. The binder having such a crosslinking functional group is coated and then heated, whereby a crosslinked structure can be formed.

### [Light-Scattering Particles]

In the light-scattering sheet in accordance with the invention, light-transmitting particles can be used as the light-scattering body. The light-scattering particles may be monodisperse organic fine particles or monodisperse inorganic fine particles. As the particle size is less dispersed, fluctuation in the light-scattering properties decrease, which serves to facilitate designing of the light-scattering film. The light-transmitting fine particles are preferably a plastic beads, and plastic beads having high transparency and giving the above-described numerical value as the difference in the refractive index from the light-transmitting resin is more preferred. Examples of the organic fine particles to be used include a polymethyl methacrylate beads (refractive index: 1.49), acryl-styrene copolymer beads (refractive index: 1.54), melamine formaldehyde beads (refractive index: 1.65), polycarbonate beads (refractive index: 1.57), styrene beads (refractive index: 1.60), crosslinked polystyrene beads (refractive index: 1.61), polyvinyl chloride beads (refractive index: 1.60), and benzoguanamine-melamine formaldehyde beads (refractive index: 1.68). Examples of the inorganic fine particles to be used include titanium silica beads (refractive index: from 1.53 to 2.00) and alumina beads (refractive index: 1.63). The light-transmitting fine particles are suitably contained in an amount of from 5 to 30 parts by weight per 100 parts by weight of the light-transmitting resin.

In the case of the above-described light-transmitting fine particles, the light-transmitting fine particles readily precipitate in the resin composition (light-transmitting resin) and therefore, for preventing the precipitation, an inorganic filler such as silica may be added. Additionally, as the amount of the inorganic filler added is increased, this is effective for preventing the precipitation of the light-transmitting fine particles but causes an adverse effect on the transparency of the film coating. Accordingly, an inorganic filler having a particle size of 0.5 μm or less is preferably contained in the light-transmitting resin in an amount of less than about 0.1 weight % to an extent of not impairing the transparency of the film coating.

[Photo-Polymerization Initiator]

Examples of the photoradical polymerization initiator include acetophenones, benzoins, benzophenones, phosphine oxides, ketals, anthraquinones, thioxanthones, azo compounds, peroxides (see, for example, JP-A-2001-139663), 2,3-dialkyldione compounds, disulfide compounds, fluoroamine compounds, aromatic sulfoniums, lophine dimers, onium salts, borate salts, active esters, active halogens, inorganic complexes, and coumarins.

These initiators may be used independently or as a mixture thereof. Various examples are also described in Saishin UV Koka Gijutsu (Newest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

Preferred examples of the commercially available photoradical polymerization initiator include KAYACURE (e.g., DETX-S, BP-100, BDMK, CTX, BMS, 2-EAQ, ABQ, CPTX, EPD, ITX, QTX, BTC, and MCA) manufactured by Nippon Kayaku Co., Ltd.; IRGACURE (e.g., 651, 184, 500, 819, 907, 369, 1173, 1870, 2959, 4265, and 4263) manufactured by Ciba Specialty Chemicals Corp.; Esacure (KIP100F, KB1, EB3, BP, X33, KT046, KT37, KIP150, and TZT) manufactured by Sartomer Company Inc.; and a combination thereof.

The photo-polymerization initiator is preferably used in an amount of from 0.1 to 15 parts by weight, more preferably from 1 to 10 parts by weight, per 100 parts by weight of the polyfunctional monomer.

### [Surface State Improver]

In the coating solution to be used for preparing any layer on the support, at least either a fluorine-based surface state improver or a silicone-based surface state improver is preferably added so as to improve the surface state failure (e.g., coating unevenness, drying unevenness, and point defect).

The surface state improver preferably changes the surface tension of the coating solution by 1 mN/m or more. Here, when the surface tension of the coating solution is changed by 1 mN/m or more, this means that the surface tension of the coating solution after the addition of the surface state improver, including the concentration process upon coating/drying, is changed by 1 mN/m or more as compared with the surface tension of the coating solution where the surface state improver is not added. A surface state improver having an effect of reducing the surface tension of the coating solution by 1 mN/m or more is preferred, a surface state improver reducing the surface tension by 2 mN/m or more is more preferred, and a surface state improve reducing the surface tension by 3 mN/m or more is still more preferred.

Preferred examples of the fluorine-based surface state improver include a compound having a fluoroaliphatic group. Preferred examples of the compound include compounds described in JP-A-2005-115359, JP-A-2005-221963, and JP-A-2005-234476.

### [Coating Solvent]

As the solvent to be used in the coating composition for forming each layer of the invention, various solvents selected, for example, from the standpoint whether the solvent can dissolve or disperse each component, readily provides a uniform surface state in the coating step and drying step, can ensure liquid storability, or has an appropriate saturated vapor pressure, may be used.

Two or more kinds of solvents may be mixed to use. In view of the drying load, it is preferred that a solvent having a boiling point of 100° C. or less at room temperature under atmospheric pressure is used as the main component and a small amount of a solvent having a boiling point of 100° C. or more is contained for adjusting the drying speed.

Examples of the solvent having a boiling point of 100° C. or less include hydrocarbons such as hexane (boiling point: 68.7° C.), heptane (98.4° C.), cyclohexane (80.7° C.), and benzene (80.1° C.); halogenated hydrocarbons such as dichloromethane (39.8° C.), chloroform (61.2° C.), carbon tetrachloride (76.8° C.), 1,2-dichloroethane (83.5° C.), and trichloroethylene (87.2° C.); ethers such as diethyl ether (34.6° C.), diisopropyl ether (68.5° C.), dipropyl ether (90.5° C.), and tetrahydrofuran (66° C.); esters such as ethyl formate (54.2° C.), methyl acetate (57.8° C.), ethyl acetate (77.1° C.), and isopropyl acetate (89° C.); ketones such as acetone (56.1° C.) and 2-butanone (same as methyl ethyl ketone, 79.6° C.); alcohols such as methanol (64.5° C.), ethanol (78.3° C.), 2-propanol (82.4° C.), and 1-propanol (97.2° C.); cyano compounds such as acetonitrile (81.6° C.) and propionitrile (97.4° C.); and carbon disulfide (46.2° C.). Among these, ketones and esters are preferred, with ketones being particularly preferred. Out of ketones, 2-butanone is particularly preferred.

Examples of the solvent having a boiling point of 100° C. or more include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (same as MIBK, 115.9° C.), 1-butanol (117.7° C.), N,N-dimethylformamide (153° C.), N,N-dimethylacetamide (166° C.), and dimethyl sulfoxide (189° C.). Among these, cyclohexanone and 2-methyl-4-pentanone are preferred.

The constituent layers which can be added in the light-scattering sheet of the invention are described below.

### [Layer Constitution of Light-Scattering Sheet]

In the light-scattering sheet of the invention, a functional group as needed according to the purpose may also be provided, in addition to the light-scattering layer.

One preferred embodiment includes an antireflection layer stacked on the support by taking into consideration, for example, the refractive index, film thickness, number of layers, and order of layers, such that the refractive index decreases by the effect of optical interference. The simplest constitution of the antireflection layer is a constitution where only a low refractive index layer is provided by coating on a support. In order to more reduce the reflectance, the antireflection layer is preferably constituted by combining a high refractive index layer having a refractive index higher than that of the support and a low refractive index layer having a refractive index lower than that of the support. Examples of the constitution include a two-layer constitution composed of high refractive index layer/low refractive index layer from the support side, and a constitution formed by stacking three layers differing in the refractive index in the order of a medium refractive index layer (a layer having a refractive index higher than that of the support or the hardcoat layer but lower than that of the high refractive index layer)/a high refractive index layer/a low refractive index layer. A constitution where a larger number of antireflection layers are stacked is also proposed. Above all, in view of durability, optical properties, cost, and productivity, the antireflection layer is preferably coated on a support having thereon a hardcoat layer, in the order of a medium refractive index layer/a high refractive index layer/a low refractive index layer. Examples thereof include constitutions described in JP-A-8-122504, JP-A-8-110401, JP-A-10-300902, JP-A-2002-243906, and JP-A-2000-111706.

Other functions may also be imparted to each layer, and examples thereof include an anti-staining low refractive index layer and an antistatic high refractive index layer (see, for example, JP-A-10-206603 and JP-A-2002-243906).

Preferred examples of the layer constitution for the antireflection sheet in accordance with the invention are described below. The antireflection sheet of the invention is not limited only to these layer constitutions if the reflectance can be reduced by optical interference. In the following constitutions, the support film means a support constituted by a film. In the constituents, it is also possible to impart an antiglare function to the light-scattering layer.
Support film/light-scattering layer/low refractive index layer
Support film/light-scattering layer/antistatic layer/low refractive index layer
Support film/hardcoat layer/light-scattering layer/low refractive index layer
Support film/hardcoat layer/light-scattering layer/antistatic layer/low refractive index layer
Support film/hardcoat layer/antistatic layer/light-scattering layer/low refractive index layer
Support film/light-scattering layer/high refractive index layer/low refractive index layer
Support film/light-scattering layer/antistatic layer/high refractive index layer/low refractive index layer
Support film/light-scattering layer/medium refractive index layer/high refractive index layer/low refractive index layer
Support film/light-scattering layer/high refractive index layer/low refractive index layer
Antistatic layer/support film/light-scattering layer/medium refractive index layer/high refractive index layer/low refractive index layer
Support film/antistatic layer/light-scattering layer/medium refractive index layer/high refractive index layer/low refractive index layer
Antistatic layer/support film/light-scattering layer/medium refractive index layer/high refractive index layer/low refractive index layer
Antistatic layer/support film/light-scattering layer/high refractive index layer/low refractive index layer/high refractive index layer/low refractive index layer

Another preferred embodiment is an optical film where layers necessary for imparting hardcoat properties, moisture-proof properties, gas-barrier properties, antiglare properties, anti-staining properties, and the like are provided without positively using optical interference.

Preferred examples of the layer constitution for the film of the above-described embodiment are described below. In the following constitutions, the support film means a support constituted by a film.
Support film/light-scattering layer/hardcoat layer
Support film/light-scattering layer
Support film/light-scattering layer/antiglare layer
Support film/hardcoat layer/light-scattering layer
Support film/light-scattering layer/hardcoat layer
Support film/antistatic layer/light-scattering layer
Support film/moisture-proof layer/light-scattering layer
Support film/gas-barrier film/light-scattering layer
Support film/light-scattering layer/anti-staining layer
Antistatic layer/support film/light-scattering layer
Light-scattering layer/support film/antistatic layer

These layers can be formed by vapor deposition, atmospheric plasma, coating, or the like. In view of productivity, these layers are preferably formed by coating.

Each constituent layer is described below.

### (1) Hardcoat Layer

In the film of the present invention, a hardcoat layer can be preferably provided on one surface of the transparent support so as to impart physical strength to the film. The hardcoat layer may be composed of a stack of two or more layers.

In view of optical design for obtaining an antireflection film, the refractive index of the hardcoat layer in the present invention is preferably from 1.48 to 2.00, more preferably from 1.52 to 1.90, still more preferably from 1.55 to 1.80. In the preferred embodiment of the present invention where at least one low refractive index layer is present on a hardcoat layer, when the refractive index is smaller than the lower limit described above, there results decreased antireflection properties whereas, when it is larger than the upper limit, color tint of reflected light tends to be intensified.

From the standpoint of imparting satisfactory durability and impact resistance to the film, the thickness of the hardcoat layer is usually from about 0.5 μm to about 50 μm, preferably from 1 μm to 20 μm, more preferably from 2 μm to 10 μm, most preferably from 3 μm to 7 μm.

The strength of the hardcoat layer is preferably H or more, more preferably 2H or more, most preferably 3H or more, in the pencil hardness test.

Furthermore, in the Taber test according to JIS K-5400, the abrasion loss of the specimen between before and after test is preferably smaller.

The hardcoat layer is preferably formed through a crosslinking reaction or polymerization reaction of an ionizing radiation-curable compound. For example, a coating composition containing an ionizing radiation-curable polyfunctional monomer or polyfunctional oligomer is coated on a transparent support, and a crosslinking or polymerization reaction of the polyfunctional monomer or polyfunctional oligomer is caused, whereby the hardcoat layer can be formed.

The functional group in the ionizing radiation-curable polyfunctional monomer or polyfunctional oligomer is preferably a photo-, electron beam- or radiation-polymerizable functional group, more preferably a photopolymerizable functional group.

Examples of the photopolymerizable functional group include an unsaturated polymerizable functional group such as a (meth)acryloyl group, a vinyl group, a styryl group, and an allyl group. Among these, a (meth)acryloyl group is preferred.

For the purpose of controlling the refractive index of the hardcoat layer, a high refractive index monomer, inorganic fine particles or both of them may be added to the binder of the hardcoat layer. The inorganic fine particles have an effect of suppressing curing shrinkage ascribable to the crosslinking reaction, in addition to the effect of controlling the refractive index. In the invention, a polymer which is produced by polymerizing the above-described polyfunctional monomer and/or high refractive index monomer or the like after the formation of the hardcoat layer is referred to as a binder, including the inorganic particle dispersed therein.

On the other hand, in the case of imparting an antiglare function by the use of surface scattering of the hardcoat layer, the surface haze is preferably from 5 to 15%, more preferably from 5 to 10%.

### (2) Antiglare Layer

The antiglare layer is formed for the purpose of imparting to the film antiglare properties and, preferably, hardcoat properties for enhancing the scratch resistance of the film.

Known examples of the method for imparting antiglare properties include a method of forming the antiglare layer by laminating a mat-shaped film having fine unevenness on its surface as described in JP-A-6-16851; a method of forming the antiglare layer by causing curing shrinkage of an ionizing radiation-curable resin due to difference in the irradiation dose of ionizing radiation as described in JP-A-2000-206317; a method of decreasing through drying the weight ratio of good solvent to the light-transmitting resin, thereby gelling and solidifying light-transmitting fine particles and light-transmitting resin to form unevenness on the film coating surface as described in JP-A-2000-338310; a method of imparting surface unevenness by applying an external pressure as described in JP-A-2000-275404; and a method of forming surface unevenness by utilizing phase separation which occurs in the process of vaporizing a solvent from a mixed solution comprising a plurality of polymers as described in JP-A-2005-195819. These known methods can be utilized.

### (3) High Refractive Index Layer, Medium Refractive Index Layer

In the light-scattering sheet in accordance with the invention, when a high refractive index layer and a medium refractive index layer are provided and optical interference is utilized together with a low refractive index layer to be described later, the antireflection property can be enhanced.

In the following description of the invention, these high refractive index layer and medium refractive index layer are sometimes collectively referred to as a high refractive index layer. Additionally, in the invention, the terms “high”, “medium” and “low” in the high refractive index layer, medium refractive index layer, and low refractive index layer indicate the relative size of the refractive index among layers. In terms of relationship with the transparent support, the refractive indexes preferably satisfy the relationships of transparent support>low refractive index layer, and high refractive index layer>transparent support.

Also, in this specification, these high refractive index layer, medium refractive index layer, and low refractive index layer are sometimes collectively referred to as an antireflection layer.

For preparing an antireflection sheet by forming a low refractive index layer on a high refractive index layer, the refractive index of the high refractive index layer is preferably from 1.55 to 2.40, more preferably from 1.60 to 2.20, still more preferably from 1.65 to 2. 10, and most preferably from 1.80 to 2.00.

In the case of preparing an antireflection sheet by providing a medium refractive index layer, a high refractive index layer, and a low refractive index layer in the order closer to the support, the refractive index of the high refractive index layer is preferably from 1.65 to 2.40, more preferably from 1.70 to 2.20. The refractive index of the medium refractive index layer is adjusted to a value between the refractive index of the low refractive index layer and the refractive index of the high refractive index layer. The refractive index of the medium refractive index layer is preferably from 1.55 to 1.80.

Specific examples of the inorganic particles for use in the high refractive index layer or medium refractive index layer include TiO₂, ZrO₂, Al₂O₃, In₂O₃, ZnO, SnO₂, Sb₂O₃, ITO, and SiO₂. TiO₂ and ZrO₂ are particularly preferred in view of increasing the refractive index. It is also preferred to subject the surface of the inorganic filler to a silane coupling treatment or a titanium coupling treatment. A surface treating agent having a functional group capable of reacting with the binder species on the filler surface is preferably used.

The content of the inorganic particles in the high refractive index layer is preferably from 10 to 90 weight %, more preferably from 15 to 80 weight %, still more preferably from 15 to 75 weight %, based on the weight of the high refractive index layer. Two or more kinds of inorganic particles may be used in combination in the high refractive index layer.

In the case of having a low refractive index layer on the high refractive index layer, the refractive index of the high refractive index layer is preferably higher than the refractive index of the transparent support.

In the high refractive index layer, a binder obtained by a crosslinking or polymerization reaction, for example, of an aromatic ring-containing ionizing radiation-curable compound, an ionizing radiation-curable compound containing a halogen element (e.g., Br, I, Cl) except for fluorine, or an ionizing radiation-curable compound containing an atom such as S, N and P may also be preferably used.

The thickness of the high refractive index layer may be appropriately designed according to the use. In the case of using the high refractive index layer as an optical interference layer to be described later, the thickness is preferably from 30 to 200 nm, more preferably from 50 to 170 nm, still more preferably from 60 to 150 nm.

In the case of not containing particles imparting an antiglare function, the haze of the high refractive index layer is preferably lower. The haze is preferably 5% or less, more preferably 3% or less, still more preferably 1% or less. The high refractive index layer is preferably formed on the transparent support directly or through another layer.

### (4) Low Refractive Index Layer

A low refractive index layer is preferably used for reducing the reflectance of the light-scattering sheet in accordance with the invention.

The refractive index of the low refractive index layer is preferably from 1.20 to 1.46, more preferably from 1.25 to 1.46, still more preferably from 1.30 to 1.40. When the refractive index of the low refractive index layer is too high, there results a high reflectance, which necessitates to increasing the refractive index of the light-scattering layer for reducing the reflectance, thus such refractive index of the low refractive index layer not being preferred. On the other hand, when the refractive index of the low refractive index layer is too low, there results reduction of the strength of the low refractive index layer, thus such refractive index not being preferred. In addition, materials to be used are limited, which leads to high production cost, thus such refractive index not being preferred.

The thickness of the low refractive index layer is preferably from 50 to 200 nm, more preferably from 70 to 100 nm. The haze of the low refractive index layer is preferably 3% or less, more preferably 2% or less, and most preferably 1% or less. The strength of the low refractive index layer is specifically, in the pencil hardness test with a load of 500 g, preferably H or more, more preferably 2H or more, most preferably 3H or more.

Also, in order to improve the anti-staining performance of the light-scattering sheet, the contact angle for water on the surface is preferably 90° or more, more preferably 95° or more, still more preferably 100° or more.

The preferred embodiment of the curing material composition includes, for example, (A) a composition containing a fluorine-containing polymer having a crosslinking or polymerizable functional group, (B) a composition mainly comprising a hydrolysis condensate of a fluorine-containing organosilane material, and (C) a composition containing a monomer having two or more ethylenically unsaturated groups and inorganic fine particles having a hollow structure.

### (A) Fluorine-Containing Compound Having Crosslinking or Polymerizable Functional Group

The fluorine-containing compound having a crosslinking or polymerizable functional group includes a copolymer of a fluorine-containing monomer with a monomer having a crosslinking or polymerizable functional group. Examples of the fluorine-containing monomer include fluoroolefins (e.g., fluoroethylene, vinylidene fluoride, tetrafluoroethylene, hexafluoropropylene, hexafluoropropylene, and perfluoro-2,2-dimethyl-1,3-dioxol), partially or completely fluorinated alkyl ester derivatives of (meth)acrylic acid (e.g., “Viscoat 6FM” manufactured by Osaka Organic Chemical Industry Ltd., “M-2020” manufactured by Daikin Industries, Ltd.), and completely or partially fluorinated vinyl ethers.

One embodiment of the monomer for imparting a crosslinking group is a (meth)acrylate monomer previously having a crosslinking functional group in the molecule, such as glycidyl methacrylate. Another embodiment is a method wherein a fluorine-containing copolymer is synthesized using a monomer having a functional group such as hydroxyl group and, thereafter, a monomer for modifying the substituent to introduce a crosslinking or polymerizable functional group is further used. Examples of the monomer include a (meth)acrylate monomer having a carboxyl group, a hydroxyl group, an amino group, a sulfonic acid group or the like (for example, (meth)acrylic acid, methylol (meth)acrylate, hydroxylalkyl (meth)acrylate and allyl acrylate). The latter embodiment is disclosed in JP-A-10-25388 and JP-A-10-147739.

The fluorine-containing copolymer may contain an appropriate copolymerizable component in view of solubility, dispersibility, coating properties, anti-staining properties, and antistatic properties. Particularly, for imparting anti-staining properties and slipperiness, silicone is preferably introduced, and this may be introduced into both the main chain and the side chain.

Examples of the method for introducing a polysiloxane partial structure into the main chain include a method using a polymer-type initiator such as azo group-containing polysiloxane amide {as the commercial product, VPS-0501 and VPS-1001 (trade names; manufactured by Wako Pure Chemicals Industries, Ltd.) described in JP-A-6-93100. Examples of the method for the introduction into the side chain include a method of introducing a polysiloxane having a reactive group at one terminal (for example, Silaplane series (manufactured by Chisso Corp.) by a polymer reaction as described in J. Appl. Polym. Sci., Vol. 2000, page 78 (1955) and JP-A-56-28219; and a method of polymerizing a polysiloxane-containing silicon macromer. Both methods may be preferably used.

With the polymer above, as described in JP-A-2000-17028, a curing agent having a polymerizable unsaturated group may be appropriately used in combination. Also, as described in JP-A-2002-145952, combination use with a compound having a fluorine-containing polyfunctional polymerizable unsaturated group is preferred. Examples of the compound having a polyfunctional polymerizable unsaturated group include the above-described monomer having two or more ethylenically unsaturated groups. A hydrolysis condensate of organosilane described in JP-A-2004-170901 is also preferred, and a hydrolysis condensate of organosilane containing a (meth)acryloyl group is particularly preferred.

These compounds are preferred particularly when a compound having a polymerizable unsaturated group is used for the polymer body, because the use of these compounds is greatly effective for the improvement of scratch resistance.

In the case where the polymer itself does not have sufficiently high curability by itself, necessary curability can be imparted by blending a crosslinking compound. For example, when the polymer body contains a hydroxyl group, various amino compounds are preferably used as the curing agent. The amino compound to be used as the crosslinking compound is a compound containing two or more groups in total of either one or both of a hydroxyalkylamino group and an alkoxyalkylamino group, and specific examples thereof include a melamine-based compound, a urea-based compound, a benzoguanamine-based compound, and a glycoluril-based compound. For the curing of such a compound, an organic acid or a salt thereof is preferably used.

Specific examples of the fluorine-containing polymer are described in JP-A-2003-222702 and JP-A-2003-183322.

### (B) Hydrolysis Condensate of Fluorine-Containing Organosilane Material

The composition mainly comprising a hydrolysis condensate of a fluorine-containing organosilane compound is also preferred because of low refractive index and high hardness of the coated film surface. A condensate of a compound containing a hydrolyzable silanol at one terminal or both terminals with respect to the fluorinated alkyl group and a tetraalkoxysilane is preferred. Specific examples of the composition are described in JP-A-2002-265866 and Japanese Patent 317,152.

### (C) Composition Containing Monomer Having Two or More Ethylenically Unsaturated Groups and Inorganic Fine Particles Having Hollow Structure

A still another preferred embodiment is a low refractive index layer comprising low refractive index particles and a binder. The low refractive index particles may be either organic or inorganic, but particles having a cavity in the inside thereof are preferred. Specific examples of the hollow particles include silica-based particles described in JP-A-2002-79616. The refractive index of the particles is preferably from 1.15 to 1.40, more preferably from 1.20 to 1.30. The binder includes the monomer having two or more ethylenically unsaturated groups described above on the page of light-diffusing layer.

In the low refractive index layer of the invention, a polymerization initiator described above on the page of light-scattering layer is preferably added. In the case of containing a radical polymerizable compound, the polymerization initiator can be used in an amount of from 1 to 10 parts by weight, preferably from 1 to 5 parts by weight, based on the weight of the compound.

In the low refractive index layer of the invention, inorganic particles can be used in combination. In order to impart scratch resistance, fine particles having a particle size corresponding to 15 to 150%, preferably from 30 to 100%, more preferably from 45 to 60%, of the thickness of the low refractive index layer may be used.

Conventionally known polysiloxane based or fluorine based antifoulants, or slipperiness agents may be appropriately added to the low refractive index layer of the invention, in purpose of imparting antifouling properties, water-resistant properties, chemical-resistant properties and slipperiness, or the like.

### (5) Antistatic Layer

In the invention, an antistatic layer is preferably provided from the standpoint of preventing electrostatic charge on the film surface. Examples of the method for forming the antistatic layer include conventionally known methods such as a method of coating an electrically conductive coating solution containing electrically conductive fine particles and a reactive curable resin, and a method of vapor-depositing or sputtering a transparent film-forming metal or metal oxide or the like to form an electrically conductive thin film. The antistatic layer may be formed on the support directly or through a primer layer ensuring firm adhesion to the support. Also, the antistatic layer may be used as a part of the antireflection layer. In this case, when the antistatic layer is used as a layer closer to the outermost surface layer, sufficiently high antistatic property can be obtained even if the layer thickness is small.

The thickness of the antistatic layer is preferably from 0.01 to 10 μm, more preferably from 0.03 to 7 μm, still more preferably from 0.05 to 5 μm. The surface resistance of the antistatic layer is preferably from 10⁵ to 10¹² Ω/sq, more preferably from 10⁵ to 10⁹ Ω/sq, most preferably from 10⁵ to 10⁸ Ω/sq. The surface resistance of the antistatic layer can be measured by a four-probe method.

It is preferred that the antistatic layer is substantially transparent. Specifically, the haze of the antistatic layer is preferably 10% or less, more preferably 5% or less, still more preferably 3% or less, most preferably 1% or less. The transmittance for light at a wavelength of 550 nm is preferably 50% or more, more preferably 60% or more, still more preferably 65% or more, most preferably 70% or more.

Preferably, the antistatic layer of the invention is excellent in the surface strength. Specifically, the surface strength of the antistatic layer is, in terms of the pencil hardness with a load of 1 kg, preferably H or more, more preferably 2H or more, still more preferably 3H or more, most preferably 4H or more.

### [Coating Solvent]

Out of these constituent layers, the layer coated in adjacency to the support film preferably contains at least one or more kinds of solvents capable of dissolving the support film and at least one or more kinds of solvents incapable of dissolving the support film. By employing such an embodiment, excessive penetration of the adjacent layer component into the support film can be prevented and, at the same time, the adhesion between the adjacent layer and the support film can be ensured. Furthermore, at least one kind of a solvent out of the solvents capable of dissolving the support film preferably has a boiling point higher than the boiling point of at least one kind of a solvent out of the solvents incapable of dissolving the support film. More preferably, the difference in the boiling point between a solvent having the highest boiling point out of the solvents capable of dissolving the support film and a solvent having the highest boiling point out of the solvents incapable of dissolving the support film is 30° C. or more. This difference is most preferably 40° C. or more.

The weight ratio (A/B) between the total amount (A) of the solvents capable of dissolving the transparent support film and the total amount (B) of the solvents incapable of dissolving the transparent support film is preferably from 5/95 to 50/50, more preferably from 10/90 to 40/60, still more preferably from 15/85 to 30/70.

### <Support for Light-Scattering Layer>

The support of the light-scattering sheet of invention may be a transparent resin film, a transparent resin plate, a transparent resin sheet, a transparent glass or the like and is not particularly limited. Examples of the transparent resin film include a cellulose acylate film (e.g., cellulose triacetate film (refractive index: 1.48), cellulose diacetate film, cellulose acetate butyrate film, or cellulose acetate propionate film), a polyethylene terephthalate film, a polyethersulfone film, a polyacrylic resin film, a polyurethane-based resin film, a polyester film, a polycarbonate film, a polysulfone film, a polyether film, a polymethylpentene film, a polyether ketone film, a (meth)acrylnitrile film, a polyolefin, and a polymer having an alicyclic structure [norbornene-based resin (ARTON: trade name; manufactured by JSR Corp.), noncrystalline polyolefin (ZEONEX: trade name; manufactured by ZEON Corp.)]. Among these, triacetyl cellulose, polyethylene terephthalate, and a polymer having an alicyclic structure are preferred, with triacetyl cellulose being particularly preferred.

A support having a thickness of approximately from 25 to 1,000 μm may be usually used, but the thickness is preferably from 25 to 250 μm, more preferably from 30 to 90 μm.

A support having an arbitrary width may be used but, in view of handling, yield ratio and productivity, the width is usually from 100 to 5,000 mm, preferably from 800 to 3,000 mm, more preferably from 1,000 to 2,000 mm. The support can be handled as a lengthy support in a roll form, and the length is usually from 100 to 5,000 m, preferably from 500 to 3,000 m.

The surface of the support is preferably smooth, and the average roughness Ra value is preferably 1 μm or less, more preferably from 0.0001 to 0.5 μm, still more preferably from 0.001 to 0.1 μm.

### <Cellulose Acylate Film>

Among those various films, a cellulose acylate film having high transparency and less optical birefringence, permitting easy production, and being generally used as a polarizing plate protective film is preferred.

As regards the cellulose acylate film, various techniques for improving mechanical characteristics, transparency, planarity and the like are known, and the technique described in Journal of Technical Disclosure, No. 2001-1745 can be used as a known art for the film of the invention.

### (Preparation of Polarizing Film)

Materials which can be used for the polarizing film are described below. A protective film may be disposed on one side or both sides of a polarizing film, and the resulting film may be used as a polarizing film.

The polarizing film includes an iodine-based polarizing film, a dye-based polarizing film using a dichroic dye, and a polyene-based polarizing film. The iodine-based polarizing film and the dye-based polarizing film are generally produced using a polyvinyl alcohol-based film.

The slow axis of the transparent support or cellulose acetate film of the antireflection film and the transmission axis of the polarizing film are arranged to run substantially in parallel.

Moisture permeability of the protective film is important for the productivity of the polarizing plate. The polarizing film and the protective film are laminated with an aqueous adhesive, and the solvent of this adhesive diffuses through the protective film and is thereby dried. As the moisture permeability of the protective film is higher, the drying rate and in turn the productivity are more elevated. However, when the moisture permeability is excessively high, moisture enters into the polarizing film depending on the environment (at high humidity) where the liquid crystal display device is used, thus the polarizing ability decreasing.

The moisture permeability of the protective film is determined, for example, by the thickness of transparent support or polymer film (and polymerizable liquid crystal compound), the free volume or the hydrophilicity/hydrophobicity.

The moisture permeability of the protective film is preferably from 100 to 1,000 g/m²·24 hrs, more preferably from 300 to 700 g/m²·24 hrs.

In order to enhance the contrast ratio of a liquid crystal display device, the transmittance of the polarizing plate preferably has an increased transmittance and, also, has preferably an increased polarizing degree. The transmittance of the polarizing plate for a light of 550 nm in wavelength is in the range of preferably from 30 to 50%, more preferably from 35 to 50%, most preferably from 40 to 50%. The polarizing degree thereof for a light of 550 nm in wavelength is in the range of preferably from 90 to 100%, more preferably from 95 to 100%, still more preferably from 99 to 100%.

The polarizing film may be a known polarizing film or a polarizing film cut out from a lengthy polarizing film with the absorption axis of the polarizing film being neither parallel nor perpendicular to the longitudinal direction. The lengthy polarizing film with the absorption axis of the polarizing film being neither parallel nor perpendicular to the longitudinal direction is produced by the following method.

That is, this is a polarizing film stretched by applying a tension to a continuously fed polymer film while holding its both edges with holding means, and can be produced by a stretching method of stretching the film to 1.1 to 20.0 times at least in the film width direction and bending the film-travelling direction in the state of the film being held at both edges, where the difference in the travelling speed in the longitudinal direction between the holding devices at both edges of the film is within 3%, such that the angle made by the film-travelling direction at the outlet in the step of holding both edges of the film and the substantial stretching direction of the film is inclined at 20 to 70°. Particularly, a polarizing film produced with an inclination angle of 45° is preferred in view of productivity.

It is preferred to use, as the protective film for the polarizing film, aforesaid stretched polymer film or the optical compensatory sheet having the optically anisotropic layer. Also, as a protective film on one side, the light-scattering sheet of the invention is preferably used on the outermost surface side of a liquid crystal display device.

Combined use of the optical compensatory sheet (retardation film) and the light-scattering sheet enables to improve tint characteristics and contrast of a liquid crystal display device.

### (Combination of Optical Compensatory Sheet and Light-Scattering Sheet)

In an embodiment in accordance with the invention, an optical compensatory sheet with which the luminance in the normal direction with respect to the liquid crystal display device in the black display state without the light-scattering sheet is 0.3 cd/m² or less, the maximum value of black luminance in the polar angle range within 60° with respect to the normal direction is 2.0 cd/m² or less is combined with a light-scattering sheet having the total haze of from 30 to 90% to provide a liquid crystal display device which corrects viewing angle dependence of tint of display in the white display state and in the black display state and which suppresses reduction of contrast.

In the invention, the phrase “in the black display state without the light-scattering sheet” is used to mean that “in the black display state of a display device wherein the protective film for the display-side polarizing film is plane TAC having no light-scattering layer and no antiglare layer”. That is, measurement of luminance in the invention means measurement of luminance of a display device in a state where no light-scattering sheet is provided on the display surface side as is different from a general display device, thus the device not having light-scattering function.

The optical compensatory sheet compensates retardation change accompanying alignment of the liquid crystal cell of a liquid crystal display device. Here, black display can be sufficiently compensated, but the optical compensatory sheet fails to completely compensate change in tint of the liquid crystal display device. Therefore, with a liquid crystal display device which shows a low black luminance in all directions, there arises a demerit that change in tint in a black display state and in a white display state particularly in an oblique direction becomes large. As has been described hereinbefore, this is caused mainly by the wavelength dispersion of the optically anisotropic layer of the optical compensatory sheet and the wavelength dispersion of a liquid crystal used in the cell.

On the other hand, it is possible to reduce change in tint which is the above-mentioned subject but, when light is scattered in an enough amount to reduce change in tint, light entering around the front screen becomes strong, thus contrast being reduced. That is, when the luminance in the normal direction with respect to a display device does not exceed 0.3 cd/m², the intrinsic contrast of the display device in the front direction is not reduced due to the low black luminance in the front direction. Also, when the maximum value of black luminance in the polar angle range within 60° with respect to the normal direction does not exceed 2.0 cd/m², the contrast in the front direction is not seriously reduced when the light-scattering sheet is disposed. When the haze of the light-scattering sheet is not less than 30%, correction of tint becomes sufficient whereas, when the haze does not exceed 90%, the amount of scattered light does not become so large that the contrast in the front direction is not reduced.

In the invention, the maximum value of the black luminance is 2.0 cd/m² or less. In a display device, as the luminance upon black display approaches 0, the black display acquires larger blackness (brightness being reduced), and hence the luminance is preferably as low as possible, with the maximum value of black luminance including zero. Although the transmitted light from a light source cannot be completely closed within the cell from the viewpoint of the cell properties, it is preferred for black luminance (maximum value of black luminance) upon black display to approach zero. In the invention, the maximum value of black luminance is preferably from 0.1 cd/m² to 2.0 cd/m², more preferably from 0.2 cd/m² to 2.0 cd/m², still more preferably from 0.3 cd/m² to 2.0 cd/m².

Accordingly, both correction of change in tint and suppression of reduction of contrast can be attained only when a liquid crystal display device having an optical compensatory sheet capable of suppressing the black luminance value in all directions in the black display is combined with a light-scattering sheet capable of reducing color shift. Such liquid crystal display device fails to attain both correction of the contrast in the front direction and suppression of viewing angle dependence of tint when outside the above-mentioned ranges.

In a conventional combination of an optical compensatory sheet and a light-scattering sheet, it has been intended to impart to the optical compensatory sheet the properties of suppressing change in tint. Therefore, an optical compensatory sheet showing the black luminance within the above-mentioned range has bad inappropriate display performance. Also, when used in a liquid crystal display device showing the black luminance within the conventional range, a light-scattering sheet causes reduction of contrast. Thus, such combination is inappropriate or, with a light-scattering sheet causing less reduction of contrast, suppression of color shift is insufficient. The combination of the optical anisotropic film of the embodiment of the invention and the light-scattering film of the embodiment of the invention cannot be thought of with ease from the prior art and cannot be designed with ease, because the optimal ranges exist in zones different from conventional concept.

### EXAMPLES

The characteristic aspects of the invention are described more specifically with reference to the following Examples and Comparative Examples. In Examples and Comparative Examples, the material used, its amount and the ratio, the details of the treatment, and the treatment order may suitably be modified or changed without overstepping the scope of the invention. Accordingly, the invention should not be limitatively interpreted by the specific examples mentioned below.

### [Preparation Example of Optical Compensation Sheet]

### (Preparation of First Optically Anisotropic Layer CA-1)

The individual components described in the following table are mixed to prepare a cellulose acylate composition. This is extruded through a die in an extrusion amount of 200 kg/hr using a biaxial kneading extruder equipped with a vacuum vent under the condition of a screw rotation number of 300 rpm and a kneading time of 40 seconds to solidify in 60° C. water, then cut to obtain cylindrical pellets of 2 mm in diameter and 3 mm in length. Then, the pellets are subjected to a melt film formation process in the same procedures as are described in JP-A-2007-2216, Example 1, to obtain 85-μm thick film. This film is stretched 60% in the MD direction at 110° C. to prepare film CA-1. Additionally, “MD direction” means the film-conveying direction. The thickness of the thus-stretched film is 67 μm.

TABLE 1
Component

| | | |
|---|---|---|
| Cellulose acylate having a degree of propionyl | 100 | parts by weight |
| substitution of 2.60 and a degree of acetyl | | |
| substitution of 0.10 | | |
| Glyerin diacetate oleate | 10 | parts by weight |
| Bis(2,4-di-tert-butylphenyl)pentaerythritol | 0.15 | part by weight |
| diphosphite | | |
| Silicon dioxide fine particles (Aerosil 972V) | 0.05 | part by weight |
| 2-(2′-Hydroxy-3′5-di-tert-butylphenyl)- | 0.05 | part by weight |
| benzotriazole | | |
| 2,4′-Hydroxy-4-methoxy-benzophenone | 0.1 | part by weight |

### (Preparation of First Optically Anisotropic Layer CA-2)

The individual components described in the following table are mixed to prepare a cellulose acylate solution. This cellulose acylate solution is cast onto a metal support, and the thus-obtained web is peeled from the support, and then stretched 20% in TD direction at 185° C. to prepare CA-2. The stretched film has a thickness of 80 μm.

TABLE 2
Component

| | | |
|---|---|---|
| Cellulose acylate having a degree of acetyl substitution of | 100 | parts by weight |
| 2.94 | | |
| Triphenyl phosphate | 3 | parts by weight |
| Biphenyl phosphate | 2 | parts by weight |
| Retardation controlling agent (1) | 5 | parts by weight |
| Retardation controlling agent (2) | 2 | parts by weight |
| Methylene chloride | 644 | parts by weight |
| Methanol | 56 | parts by weight |

Retardation controlling agent (1)

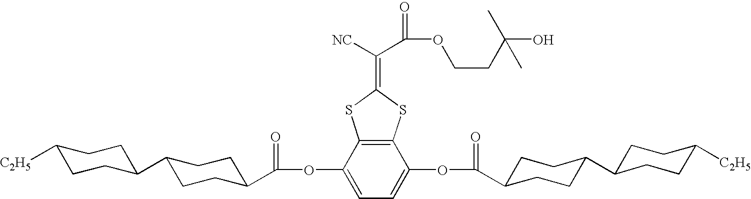

Retardation controlling agent (2)

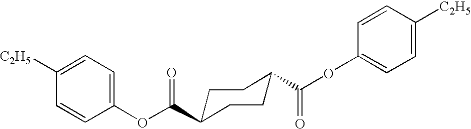

### (Preparation of First Optically Anisotropic Layer CA-3)

A cellulose acylate film obtained by a melt film formation process in the same manner as with CA-1 is stretched 95% in MD direction at 110° C. to prepare CA-3. The stretched film has a thickness of 100 μm.

Optical characteristics of the thus-prepared CA-1 to CA-3 are as follows.

TABLE 3

| | CA-1 | CA-2 | CA-3 |
|---|---|---|---|
| Re | 80 | 80 | 150 |
| Rth | 60 | 60 | 75 |
| Rth/Re | 0.8 | 0.8 | 0.5 |
| ΔRe(630-450) | 11 | 30 | 21 |
| ΔRth(630-450) | 8 | 23 | 15 |

unit: nm (excluding Rth/Re)

### <Saponification Treatment>

10 mL of a 1.0N potassium hydroxide solution (solvent: water/isopropyl alcohol/propylene glycol=69.1 parts by weight/15 parts by weight/15.8 parts by weight) is coated on each of the first optically anisotropic layers CA-1 to CA-3 and, after keeping the state at 40° C. for 30 seconds, the alkali solution is scraped away. Then, each layer is washed with pure water, followed by removing water droplets with air knife. Thereafter, each layer is dried at 100° C. for 15 seconds.

### <Preparation of Alignment Film>

The alignment film coating solution of the following formulation is coated on each of the aforesaid first optically anisotropic layers CA-1 to CA-3 having been saponification-treated and surface-treated, in a coating amount of 28 mL/m² using a #16 wire bar coater, followed by drying with a 60° C. warm air for 60 seconds and, further, with a 90° C. warm air for 150 seconds to prepare alignment films. The dried alignment films have a thickness of 1.1 μm.

| | | |
|---|---|---|
| Modified polyvinyl alcohol (described below) | 10 | parts by weight |
| Water | 371 | parts by weight |
| Methanol | 119 | parts by weight |
| Gluataraldehyde (crosslinking agent) | 0.5 | part by weight |
| Citric ester (AS-3; manufactured | 0.35 | part by weight |
| by Sankyo Kagaku K.K.) | | |

Modified polyvinyl alcohol

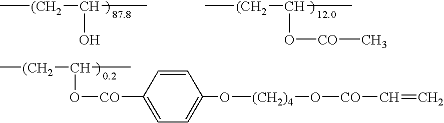

### <Alignment Treatment>

A rubbing roll (300 mm in diameter) is provided so that rubbing treatment can be performed in the direction at 90° with respect to the stretching direction by conveying each of CA-1 to CA-3 at a speed of 20 m/min, and then the rubbing roll is rotated at 750 rpm to perform rubbing treatment on the alignment film-provided surface.

### (Preparation of Optical Compensatory Sheet CB-1)

A coating solution of the formulation shown below is coated on the rubbing-treated surface of CA-1 in a dry thickness of 1.1 μm. Thereafter, it is heated for 90 seconds in a 130° C. thermostatic chamber to align the discotic liquid crystalline compound (1). Subsequently, progress of the crosslinking reaction is caused by irradiating with UV rays for 1 minute at 80° C. using a 160 W/cm high-pressure mercury lamp to thereby polymerize the discotic liquid crystalline compound (1), followed by allowing it to cool to room temperature. The Re retardation value of the thus-obtained optically anisotropic layer measured at a wavelength of 546 nm is 28 nm. CB-1 is prepared in this way.

TABLE 4
Component

| | | |
|---|---|---|
| Methyl ethyl ketone | 328 | parts by weight |
| Discotic crystalline compound (1) | 91.0 | parts by weight |
| of the following structure | | |
| Ethylene oxide-modified trimethylolpropane | 9.0 | parts by weight |
| triacrylate (V#360; manufactured by Osaka | | |
| Organic Chemical Industry Ltd.) | | |
| Cellulose acetate butyrate (CAB531-1; | 0.5 | part by weight |
| manufactured by Eastman Chemical Japan) | | |
| Fluoroalifatic group-containing copolymer | 0.3 | part by weight |
| (Megafac F780; manufactured by | | |
| Dai-Nippon Ink) | | |
| Photopolymerization initiator (Irgacure 907; | 3.0 | parts by weight |
| manufactured by Ciba Geigy) | | |
| Sensitizer (KAYACURE DETX; | 1.0 | part by weight |
| manufactured by Nippon | | |
| Kayaku Co., Ltd. | | |

discotic liquid crystalline compound (1)

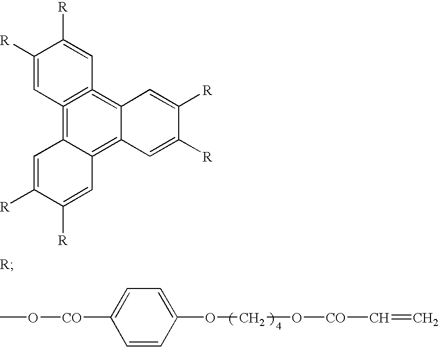

### (Preparation of Optical Compensatory Sheet CB-2)

A second optically anisotropic layer is formed in the same manner as with CB-1 except for using CA-2 in place of CA-1 as the first optically anisotropic layer to thereby prepare CB-2.

### (Preparation of Optical Compensatory Sheet CB-3)

A second optically anisotropic layer is formed in the same manner as with CB-1 except for using CA-3 in place of CA-1 as the first optically anisotropic layer to thereby prepare CB-3.

### [Preparation of Coating Solution (DA-1) for Forming Light-Scattering Layer]

100 parts by weight of dipentaerythritol hexaacrylate (manufactured by Nippon Kayaku Co., Ltd.) as a light-transmitting resin for constituting a light-scattering layer, 5 parts by weight of melamine (OPTOBEADS; manufactured by Nissan Chemical Industries, Ltd.; particle size: 1.5 μm) as light-transmitting particles, and 6 parts by weight of a polymerization initiator (Irgacure 184; Ciba Specialty Chemicals) are mixed, and a coating solution containing 50% of solid components in methyl ethyl ketone/methyl isobutyl ketone (30/70 by weight ratio) is prepared. Thus, there is obtained a coating solution DA-1 for forming a light-scattering layer.

### [Preparation of Coating Solution (DA-2) for Forming Light-Scattering Layer]

A coating solution DA-2 for forming a light-scattering layer is obtained in the same manner as in preparation of the coating solution DA-1 for forming a light-scattering layer except for changing the light-transmitting particles to melamine (OPTOBEADS 3500M; manufactured by Nissan Chemical Industries, Ltd.; particle size: 3.5 μm).

### [Preparation of Coating Solution (DA-3) for Forming Light-Scattering Layer]

A coating solution DA-3 for forming a light-scattering layer is obtained in the same manner as in preparation of the coating solution DA-1 for forming a light-scattering layer except for changing the light-transmitting particles of 5 parts by weight of melamine (OPTOBEADS 2000M; manufactured by Nissan Chemical Industries, Ltd.; particle size: 1.5 μm) to 5 parts by weight of melamine (OPTOBEADS 3500M; manufactured by Nissan Chemical Industries, Ltd.; particle size: 3.5 μm).

### [Preparation of Coating Solution (DA-4) for Forming Light-Scattering Layer]

A coating solution DA-4 for forming a light-scattering layer is obtained in the same manner as in preparation of the coating solution DA-1 for forming a light-scattering layer except for changing the light-transmitting particles to 10 parts by weight of melamine (OPTOBEADS 6500M; manufactured by Nissan Chemical Industries, Ltd.; particle size: 6.5 μm).

### [Preparation of Coating Solution (DA-5) for Forming Light-Scattering Layer]

A coating solution DA-5 for forming a light-scattering layer is obtained in the same manner as in preparation of the coating solution DA-1 for forming a light-scattering layer except for changing the light-transmitting particles to 10 parts by weight of PMMA (MX300; manufactured by Soken Chemical & Engineering Co., Ltd.; particle size: 3.5 μm).

### [Preparation of Coating Solution (LA-1) for Forming Low Refractive Index Layer]

45 g (as solid components) of an ethylenically unsaturated group-containing, fluorine-containing polymer (fluorine-containing polymer (A-1) described in JP-A-2005-89536, Production Example 3) is dissolved in 500 g of methyl isobutyl ketone and, further, 195 parts by weight of a dispersion A (containing 39.0 parts by weight of solids of silica+surface-treating agent), 30.0 parts by weight (9.0 parts by weight as solid components) of a dispersion of colloidal silica (silica: a product differing in particle size from MEK-ST; average particle size: 45 nm; concentration of solid components: 30%; manufactured by Nissan Chemical Industries, Ltd.), 7.0 parts by weight of a sol liquid B1 (containing 5.0 parts by weight of solid components), and 2.0 parts by weight of PM980M (photo-polymerization initiator; manufactured by Wako Pure Chemicals Industries, Ltd.) are added thereto. The resulting mixture is diluted with methyl ethyl ketone so that the concentration of total solid components of the coating solution becomes 6 parts by weight to obtain a coating solution (LA-1) for forming a low refractive index layer. Methods for preparing the sol liquid B1 and the dispersion A used for preparing the coating solution are shown below.

### (Preparation of Sol Liquid B1)

To a reactor equipped with a stirrer and a reflux condenser are added 120 parts by weight of methyl ethyl ketone, 100 parts by weight of acryloyloxypropyltrimethoxysilane (KBM-5103; manufactured by Shin-Etsu Chemical Co., Ltd.) and 3 parts by weight of diisopropoxyaluminum ethylacetoacetate, followed by mixing. Then, 30 parts by weight of deionized water is added thereto and, after reacting at 60° C. for 4 hours, the reaction mixture is cooled to room temperature to obtain a sol liquid a. The liquid has a weight-average molecular weight of 1,600 and, of the components having a molecular weight of oligomer, the content of components having a molecular weight of from 1,000 to 20,000 amounts to 100%. Also, gas chromatography analysis reveals that the starting acryloyloxypropyltrimethoxysilane does not remain at all.

### (Preparation of Dispersion A)

To 500 g of a sol of hollow silica fine particles (isopropyl alcohol silica sol; average particle size: 60 nm; thickness of shell: 10 nm; concentration of silica: 20% by weight; refractive index of silica fine particles: 1.31; prepared according to Preparation Example 4 in JP-A-2002-79616 with changing particle size) are added 30 g of acryloyloxypropyltrimethoxysilane (manufactured by Shin-Etsu Chemical Co., Ltd.) and 1.5 g of diisopropoxyaluminum ethyl acetate and, after mixing, 9 g of ion exchanged water is added thereto. After allowing the reaction to proceed at 60° C. for 8 hours, the reaction solution is cooled to room temperature, followed by adding thereto 1.8 g of acetylacetone. While adding cyclohexanone to 500 g of the obtained dispersion to keep a nearly constant silica content, solvent displacement by distillation under reduced pressure is performed. Generation of foreign matters in the dispersion is not observed. Subsequently, the concentration of solid components is adjusted to 20% by weight with cyclohexanone.

### [Preparation of Light-Scattering Sheet DB-1]

A coating solution (DA-1) for forming a light-scattering layer is coated on a support of triacetyl cellulose film (TD-80U; manufactured by Fuji Film Co., Ltd.) in a dry thickness of 5.0 μm and, after drying to remove the solvent, irradiated at an irradiance of 1.5 kW/cm² and a dose of 95 mJ/cm² using an air-cooled 160 W/cm metal halide lamp (manufactured by Eye Graphics Co., Ltd.) to cure the coated layer, thus a light-scattering sheet DB-1 being prepared.

### [Preparation of Light-Scattering Sheet DB-2]

A light-scattering sheet DB-2 is prepared in the same manner as in preparing the light-scattering sheet DB-1 except for using (DA-2) in place of the coating solution (DA-1) for forming the light-scattering layer and changing the dry thickness to 7.0 μm.

### [Preparation of Light-Scattering Sheet DB-3]

A light-scattering sheet DB-3 is prepared in the same manner as in preparing the light-scattering sheet DB-1 except for using (DA-3) in place of the coating solution (DA-1) for forming the light-scattering layer and changing the dry thickness to 7.0 μm.

### [Preparation of Light-Scattering Sheet DB-4]

A light-scattering sheet DB-4 is prepared in the same manner as in preparing the light-scattering sheet DB-1 except for using (DA-4) in place of the coating solution (DA-1) for forming the light-scattering layer and changing the dry thickness to 12.0 μm.

### [Preparation of Light-Scattering Sheet DB-5]

A light-scattering sheet DB-5 is prepared in the same manner as in preparing the light-scattering sheet DB-1 except for using (DA-5) in place of the coating solution (DA-1) for forming the light-scattering layer and changing the dry thickness to 7.0 μm.

### [Preparation of Light-Scattering Sheet DB-6]

A coating solution (LA-1) for forming a low refractive index layer is coated on the light-scattering sheet DB-1 in a thickness of 95 nm after drying and curing. After drying to remove the solvent, the coated layer is irradiated at an irradiance of 1.5 kW/cm² and a dose of 500 mJ/cm² using an air-cooled 160 W/cm metal halide lamp (manufactured by Eye Graphics Co., Ltd.) while purging with nitrogen so as to keep the oxygen concentration at about 100 ppm, to thereby cure the low refractive index layer, thus a light-scattering sheet DB-6 being prepared.

Optical characteristic values of the light-scattering sheets are shown below. Here, the amount of transmitted light for light entering from the perpendicular direction with respect to the light-scattering sheet is shown as I0, and the amount of scattered light toward the direction of 26° as I26.

TABLE 5

| Light- | Light- | | Light- | | Total | |
|---|---|---|---|---|---|---|
| scattering | transmitting | | transmitting | | Haze | |
| Sheet | Resin | nB | particles | nP | Value | I26/I0 |
| DB-1 | DPHA | 1.52 | Melamine | 1.65 | 47 | 0.00089 |
| DB-2 | DPHA | 1.52 | Melamine | 1.65 | 32 | 0.00046 |
| DB-3 | DPHA | 1.52 | Melamine | 1.65 | 52 | 0.00097 |
| DB-4 | DPHA | 1.52 | Melamine | 1.65 | 24 | 0.00052 |
| DB-5 | DPHA | 1.52 | PMMA | 1.50 | 12 | 0.00032 |
| DB-6 | DPHA | 1.52 | Melamine | 1.65 | 56 | 0.00089 |

Next, polarizing plates 1R to 3R on the backlight side, having the prepared optical compensatory sheets CB-1 to CB-3, respectively, as protective film; and polarizing plates 11F to 16F, 21F to 25F, and 31F to 35F on the viewer's side, each having one of the optical compensatory sheets CB-1 to CB-3 and having a light-scattering sheet DB-1 to DB-6 as protective films are prepared.

### (Preparation of Polarizing Plate on the Backlight Side)

First, iodine is adsorbed onto a stretched polyvinyl alcohol film to prepare a polarizing film.

Then, each of the aforesaid CB-1 to CB-3 is stuck to one surface of the polarizing film using a polyvinyl alcohol-based adhesive, with the side on which the second optically anisotropic layer is not formed facing the polarizing film, and a commercially available cellulose triacetate film (FUJITAC TD80UF; manufactured by Fuji Film C., Ltd.) having been subjected to the saponification treatment is stuck to the other side of the polarizing film using a polyvinyl alcohol-based adhesive. In this occasion, the direction of the rubbing treatment to which the first optically anisotropic layer is subjected and the absorption axis of the polarizing film are adjusted to be in parallel with each other. Thus, there are prepared three kinds of polarizing plates (polarizing plates 1R to 3R) on the backlight side.

### (Preparation of Polarizing Plates on the Viewer's Side)

Polarizing plates (11F to 16F, 21F to 25F, and 31F to 35F) are prepared as follows in the same manner as in preparing the polarizing plates on the backlight side except for changing the cellulose triacetate film (FUJITAC TD80UF; manufactured by Fuji Film C., Ltd.) to the light-scattering sheets DB-1 to DB-6.

TABLE 6

| | Protective Film 1 | Protective Film 2 |
|---|---|---|
| Polarizing Plate | (Optical Compensatory Sheet) | (Light-scattering Sheet) |
| 1R | CB-1 | Cellulose triacetate |
| 2R | CB-2 | Cellulose triacetate |
| 3R | CB-3 | Cellulose triadetate |
| 11F | CB-1 | DB-1 |
| 12F | CB-1 | DB-2 |
| 13F | CB-1 | DB-3 |
| 14F | CB-1 | DB-4 |
| 15F | CB-1 | DB-5 |
| 16F | CB-1 | DB-6 |
| 21F | CB-2 | DB-1 |
| 22F | CB-2 | DB-2 |
| 23F | CB-2 | DB-3 |
| 24F | CB-2 | DB-4 |
| 25F | CB-2 | DB-5 |
| 31F | CB-3 | DB-1 |
| 32F | CB-3 | DB-2 |
| 33F | CB-3 | DB-3 |
| 34F | CB-3 | DB-4 |
| 35F | CB-3 | DB-5 |

### <Preparation of Liquid Crystal Display Device for Measuring Luminance>

In a 22-inch liquid-crystal display device employing a TN-mode liquid crystal cell (manufactured by ACER; AL2216W), a pair of polarizing plates (a polarizing plate on the upper side and a polarizing plate on the lower side) are removed and, in place of them, the polarizing plates 1R to 3R prepared above are stuck each one on both the viewers' side and the backlight side, using an adhesive, in such a manner that the second optically anisotropic layer faces the side of the liquid crystal cell. Thus, there are prepared liquid crystal display devices 10, 20, and 30 having the polarizing plates 1R to 3R, respectively. In this occasion, the two polarizing plates are so disposed that the transmission axis of the polarizing plate on the viewers' side (polarizing plate on the upper side) is perpendicular to the transmission axis of the polarizing plate on the backlight side (polarizing plate on the lower side).

### <Measurement of Luminance Upon Black Display>

Each of the liquid crystal display devices having been left standing for 1 week in a room of ordinary temperature and ordinary humidity (25° C., 60% RH) is used to evaluate the luminance upon black display using a measuring apparatus (EZ-Contrast 160D; manufactured by ELDIM). Results of the evaluation are shown in the following table. It can be seen from the table that, with the optical compensatory sheets CB-1 and CB-2, the maximum value of black luminance (cd/m²) is suppressed to a low level in both the normal direction with respect to the display (black luminance in the front direction) and the direction within a polar angle of 60° with respect to the normal direction.

TABLE 7

| | | | Maximum Value of |
|---|---|---|---|
| | | | Black Luminance |
| | Optical | Black Luminance | in the Direction |
| Liquid Crystal | Compensatory | in the | of a Polar |
| Display Device | Sheet | Front Direction | Angle of 60° |
| 10 | CB-1 | 0.26 | 1.89 |
| 20 | CB-2 | 0.28 | 1.71 |
| 30 | CB-3 | 0.32 | 2.73 |

### <Preparation of Liquid Crystal Display Device of the Invention>

In a 22-inch liquid-crystal display device employing a TN-mode liquid crystal cell (manufactured by ACER; AL2216W), a pair of polarizing plates (a polarizing plate on the upper side and a polarizing plate on the lower side) are removed and, in place of them, the polarizing plates prepared above are stuck to the liquid crystal cell as described below using an adhesive, in such a manner that the second optically anisotropic layer faces the side of the liquid crystal cell. Thus, there are prepared liquid crystal display devices 11 to 16, 21 to 25, and 31 to 35, respectively. In this occasion, the two polarizing plates are so disposed that the transmission axis of the polarizing plate on the viewers' side (polarizing plate on the upper side) is perpendicular to the transmission axis of the polarizing plate on the backlight side (polarizing plate on the lower side).

### <Evaluation of Display Performance>

The liquid crystal display devices above having been left standing for 1 week in a room of ordinary temperature and ordinary humidity (25° C., 60% RH) are subjected to measurement for tint and contrast in the front direction (transmittance upon white display/transmittance upon black display) in 8 stages of from black display (L0) to white display (L7) by using a measuring apparatus (EZ-Contrast 160D, manufactured by ELDIM).

Additionally, in the following table, ΔCu′v′ indicates the distance in a u′v′ (u′v′: color coordinates in CIELAB space) space between the u′v′ value in the front direction (normal direction with respect to the display screen) and the u′v′ value of the most remote point based on the locus obtained by inclining the viewing angle to 60° from the front.

The contrast in the front direction is a value calculated from the ratio of transmittance upon white display/transmittance upon black display.

### <Evaluation Criteria>

[Evaluation Criteria of ΔCu′v′)

A: ΔCu′v′ is more than 0.02 and not more than 0.04.

B: ΔCu′v′ is more than 0.04 and not more than 0.06.

C: ΔCu′v′ is more than 0.06 and not more than 0.08.

D: ΔCu′v′ is more than 0.08 and not more than 0.10.

[Evaluation Criteria of Contrast-Viewing Angle (Polar Angle Range in which the Contrast Ratio is 10 or More and Tone Reversal on the Black Side Does Not Occur)]

A: The polar angle is more than 340° and not more than 360° in up/down, right/left directions.

B: The polar angle is more than 320° and not more than 340° in up/down, right/left directions.

C: The polar angle is more than 300° and not more than 320° in up/down, right/left directions.

D: The polar angle is more than 280° and not more than 300° in up/down, right/left directions.

TABLE 8

| Liquid | Polarizing | Polarizing | | | | |
|---|---|---|---|---|---|---|
| Crystal | Plate | Plate | Contrast in | Contrast- | | |
| Display | on Backlight | on Viewer's | the Front | Viewing | Tint | |
| Device | Side | Side | Direction | Angle | ΔCu′v′ | Example |
| 10 | 1R | 1R | 1100 | C | D | Comparative |
| | | | | | | Example |
| 11 | 1R | 11F | 900 | A | A | Example |
| 12 | 1R | 12F | 950 | A | B | Example |
| 13 | 1R | 13F | 850 | A | A | Example |
| 14 | 1R | 14F | 1000 | B | D | Comparative |
| | | | | | | Example |
| 15 | 1R | 15F | 1000 | B | D | Comparative |
| | | | | | | Example |
| 16 | 1R | 16F | 950 | A | A | Example |
| 20 | 2R | 2R | 1050 | B | D | Comparative |
| | | | | | | Example |
| 21 | 2R | 21F | 900 | A | A | Example |
| 22 | 2R | 22F | 950 | A | B | Example |
| 23 | 2R | 23F | 850 | A | A | Example |
| 24 | 2R | 24F | 1000 | B | D | Comparative |
| | | | | | | Example |
| 25 | 2R | 25F | 1000 | B | D | Comparative |
| | | | | | | Example |
| 30 | 3R | 3R | 750 | C | D | Comparative |
| | | | | | | Example |
| 31 | 3R | 31F | 650 | B | A | Comparative |
| | | | | | | Example |
| 32 | 3R | 32F | 650 | C | B | Comparative |
| | | | | | | Example |
| 33 | 3R | 33F | 600 | C | A | Comparative |
| | | | | | | Example |
| 34 | 3R | 34F | 700 | D | C | Comparative |
| | | | | | | Example |
| 35 | 3R | 35F | 700 | D | C | Comparative |
| | | | | | | Example |

It can be seen from the results shown in the above table that every liquid crystal display wherein the luminance of the light-scattering sheet in the normal direction with respect to the display device is 0.3 cd/m² or less and wherein the maximum value of black luminance in the range within a polar angle of 60° with respect to the normal direction is cd/m² or less shows a high CR in the front direction and shows good display characteristics with respect to viewing angle characteristics of contrast-viewing angle and ΔCu′v′. In particular, examples wherein the amount of scattered light in a 26° direction is within the range of from 0.0005 to 0.0015 can be understood to be excellent in both the contrast in the front direction and correction of tint.

The present invention provides a liquid crystal display device which corrects viewing angle dependence of color tint of display in the white display state and in the black display state and which suppresses reduction of contrast.

The entire disclosure of each and every foreign patent application from which the benefit of foreign priority has been claimed in the present application is incorporated herein by reference, as if fully set forth.

What is claimed is:

1. A liquid crystal display device, comprising: a light source; a polarizing film of light source side; a liquid crystal cell; and a polarizing film of display side, in this order,
the liquid crystal display device further comprising:
an optical compensatory sheet disposed between the liquid crystal cell and the polarizing film of the light source side or between the liquid crystal cell and the polarizing film of the display side; and
a light-scattering sheet disposed at an outermost surface of the polarizing film of display side,
wherein luminance in a normal direction with respect to the liquid crystal display device in a black display state without the light-scattering sheet is 0.3 cd/m² or less, maximum value of black luminance in a polar angle range within 60° with respect to the normal direction is 2.0 cd/m² or less, and total haze of the light-scattering sheet is from 30 to 90%.

2. The liquid crystal display device according to claim 1,
wherein the light-scattering sheet includes:
a transparent support; and
a light-scattering layer,
with the light-scattering layer being constituted by a light-transmitting resin and a light-scattering body,
wherein the light-transmitting resin is cured by at least one of heat and ionizing radiation, and the light-scattering body is different from the light-transmitting resin in refractive index.

3. The liquid crystal display device according to claim 2,
wherein the light-scattering body in the light-scattering sheet is light-transmitting particles.

4. The liquid crystal display device according to claim 3,
wherein a difference between a refractive index (nB) and a refractive index (nP) is from 0.03 to 0.2, the refractive index (nB) representing a refractive index of the light-transmitting resin and the refractive index (nP) representing a refractive index of the light-transmitting particles in the light-scattering sheet.

5. The liquid crystal display device according to claim 4,
wherein the refractive index (nB) is lower than the refractive index (nP).

6. The liquid crystal display device according to claim 2,
wherein the light-scattering body contained in the light-scattering sheet is particles having a particle size of from 0.5 to 6 μm.

7. The liquid crystal display device according to claim 1 further comprising:
a low refractive index layer having a refractive index of from 1.20 to 1.46, the low refractive index layer being provided over the light-scattering sheet as an antireflection layer.

8. The liquid crystal display device according to claim 1,
wherein the optical compensatory sheet has at least one of optically anisotropic layers including a first optically anisotropic layer and a second optically anisotropic layer,
the first optically anisotropic layer including at least one sheet of polymer film, and the second optically anisotropic layer being formed from a transparent support and a low-molecular or high-molecular liquid crystalline compound.

9. The liquid crystal display device according to claim 8,
wherein
the first optically anisotropic layer of the optical compensatory sheet has an optically positive mono-axial or bi-axial properties, and
the first optically anisotropic layer has a value of Re(630) which is larger than a value of Re(450), the value of Re(630) representing an in-plane retardation at a wavelength of 630 nm and the value of Re(450) representing an in-plane retardation at a wavelength of 450 nm.

10. The liquid crystal display device according to claim 8,
wherein the first optically anisotropic layer of the optical compensatory sheet satisfies following formula (A):
5 nm≦ΔRe(630−450)≦45 nm (A)
wherein ΔRe(630−450) represents a difference between Re(630) and Re(450), where Re(630) represents an in-plane retardation at wavelength of 630 nm; and Re(450) represents an in-plane retardation at wavelength of 450 nm.

11. The liquid crystal display device according to claim 8,
wherein the first optically anisotropic layer of the optical compensatory sheet satisfies following formulae (B) and (C):
50 nm≦Rth(550)≦140 nm (B)
0.5≦Rth(550)/Re(550)≦6.0 (C)
wherein Re(550) represents an in-plane retardation value to light having a wavelength of 550 nm; and Rth(550) represents a retardation value in a thickness direction to light having a wavelength of 550 nm.

12. The liquid crystal display device according to claim 8,
wherein the first optically anisotropic layer of the optical compensatory sheet satisfies following formula (D):
ΔRth(630−450)≦30 nm (D)
wherein ΔRth(630−450) represents a difference between Rth(630) and Rth(450), where Rth (630) represents a retardation value in a thickness direction to light having wavelength of 630 nm; and Rth (450) represents a retardation value in a thickness direction to light having wavelength of 450 nm.

13. The liquid crystal display device according to claim 1, wherein the liquid crystal cell is of TN-mode.
